(19) United States
(12) Patent Application Publication
(10) Pub. No.: US 2014/0317313 A1
(43) Pub. Date: Oct. 23, 2014

(54) NAT SUB-TOPOLOGY MANAGEMENT SERVER

(71) Applicants: Hideki Okita, Tokyo (JP); Yoshiko Yasuda, Tokyo (JP); Mariko Nakayama, Tokyo (JP); Yosuke Himura, Tokyo (JP); Kazuma Yumoto, Tokyo (JP)

(72) Inventors: Hideki Okita, Tokyo (JP); Yoshiko Yasuda, Tokyo (JP); Mariko Nakayama, Tokyo (JP); Yosuke Himura, Tokyo (JP); Kazuma Yumoto, Tokyo (JP)

(73) Assignee: HITACHI, LTD., Tokyo (JP)

(21) Appl. No.: 14/342,123

(22) PCT Filed: Jul. 19, 2012
(86) PCT No.: PCT/JP2012/068293

§ 371 Date: Jul. 8, 2014

(30) Foreign Application Priority Data
Aug. 29, 2011 (JP) 2011-185474

(51) Int. Cl. H04L 29/12

(52) U.S. Cl. CPC H04L 61/2557; H04L 61/6068
USPC 709/245

(57) ABSTRACT

In a network where network address translation (NAT) has been introduced, a problem occurs in which, when an IP host operating in a network is automatically categorized with automatic IP host discovery using an ARP cache, a plurality of IP hosts with the same IP address are recognized as one IP host by NAT. To resolve this problem, a network management server specifies network sub-topology on the basis of topology information, public addresses translated by NAT, and IP host corresponding relationships.

### INCORPORATION BY REFERENCE

The present application claims the priority of Japanese Patent Application No. 2011-185474 filed on Aug. 29, 2011, the contents of which are incorporated herein by reference.

### TECHNICAL FIELD

The present invention relates to a communication network technology.

### BACKGROUND ART

In a data center (DC), there often arises a situation in which an administrator wants to grasp IP hosts which are really in operation. However, there is no data base or no document for management of the IP hosts in operation. If any, the contents of the data base or the document do not match with the real state of the network. Therefore, the administrator often cannot accurately grasp the IP hosts in operation from the document or the data base.

It is a problem in this case that the administrator has to go to the site of the DC to retrieve all devices physically connected to the network inside the DC, check the setting states of IP addresses of OSs as to all the devices and create a list of IP hosts based on the results of the checked setting states. It takes lots of labor and time to do this work, causing the increase of an operating load.

An example of such a situation includes a case in which an administrator of a public cloud service provider may take over operation management of a network inside a DC from the administrator who has managed the DC. In another case, a private cloud service provider may get a new contract for operation management of a network inside a DC of a client.

Of background-art technologies for solving the aforementioned problem of grasping IP hosts, there is an automatic discovery technology for IP hosts as disclosed in Patent Literature 1 or Patent Literature 2. When this technology is used, a network management server creates a list of IP addresses of IP hosts in operation within a network based on information of an ARP (Address Resolution Protocol) table held by a router in the network. Then, the administrator can obtain the list of IP hosts based only on management information of devices in the network.

Further, based on the automatic discovery technology for IP hosts, the network management server calculates an IP segment to which each IP address belongs from setting of the IP address and setting of a subnet mask in accordance with each network interface of the router, and groups IP addresses in accordance with the IP addresses belonging to the same IP segment. In this manner, the network management server can automatically generate a group management table for management of IP hosts belonging to each IP segment.

A NAT (Network Address Translation) technology for converting IP addresses used inside and outside the network as disclosed in Patent Literature 3 and Patent Literature 4 affects the automatic discovery technology for IP hosts when it is used in a cloud service environment. When cloud service users shift their systems from an existing environment onto a cloud service, the users usually desire to continuously use IP addresses used in the existing environment, in order to suppress the time and labor for verification caused by the change in setting or in order to maintain consistency with the internal network for management.

The aforementioned NAT technology is a technology for rewriting a destination IP address or a source IP address contained in an IP header of a transmission/reception IP packet in a router inside the cloud service environment in order to achieve the users' desire. The cloud service administrator sets, in the router, correspondence between IP addresses for publicizing external sites after the conversion, which IP addresses are newly assigned to IP hosts of the users, and IP addresses before the conversion in the existing environment.

### CITATION LIST

### Patent Literature

Patent Literature 1: JP-A-11-316724
Patent Literature 2: JP-A-8-32597
Patent Literature 3: JP-A-10-13471
Patent Literature 4: JP-A-2002-217941

### SUMMARY OF INVENTION

### Technical Problem

There arises a problem that a correct classified result cannot be obtained when the aforementioned management system is used to classify the IP hosts in the cloud service environment using NAT functions. This is because two different clients may use one and the same IP address segment in the environment using NAT functions. For example, two client networks accommodated in a router performing NAT functions may continuously use an IP segment 10.0.1.0/24, which has been used in the existing environment, also in the cloud service environment. Further in this case, two IP hosts of different clients may use the same IP address.

In such a case, first, an intensive address problem occurs as a first problem. This is a problem that two IP hosts of different clients are recognized as one IP host by the network management server. In addition, an intensive group problem occurs as a second problem. This is a problem that two IP segments of different clients are recognized as one group by the network management server. In addition, an address separation problem occurs as a third problem. This is a problem that one IP host of a certain client is automatically recognized as two IP hosts, i.e. an IP host having an IP address after conversion and for use in communication with a global network side and an IP host having an IP address before conversion and for use in communication with any other IP host within a private network for the client.

To solve these problems, the administrator checks setting of IP addresses of OSs of all servers which serve as IP hosts to thereby grasp intensive IP hosts, intensive groups, and correspondence among independently recognized IP hosts. However, it takes a long working time of ten and several minutes per server to do this work. In addition, it is necessary to perform the work on all the servers to be managed. Therefore, the working time is long and the operating load is large.

Accordingly, an object of the invention is to provide a network management server which can create a list of all IP hosts in operation and correspondence between addresses for publicizing external sites after conversion using NAT functions and the IP hosts when there are IP addresses duplicate among a plurality of clients in a cloud service environment etc. in which existing IP networks of the clients are accommodated using NAT functions.

### Solution to Problem

A representative example of the invention disclosed in the present application will be shown below. That is, there is provided a network management computer which is connected to network devices including one or more address translation units, including: a memory unit which stores topology information and address translation information, the topology information indicating connection relation among the network devices, the address translation information indicating correspondence between a first IP address and a second IP address for each of first interfaces which are network interfaces of the address translation units, the correspondence being set for each of the first interfaces so that the first IP address and the second IP address can be translated from one to the other by the address translation device; and a control unit which specifies, for each of the first interfaces, a network device directly connected to the first interface or a network device connected to the first interface through another network device based on the topology information and the address translation information and stores sub-topology information into the memory unit, the sub-topology information indicating correspondence between the first interface and the network device directly connected to the first interface or the network device connected to the first interface through the other network device.

More preferably,when connection relation of a network including the network devices and the computer connected to the network devices is displayed on a viewer unit, the control unit displays a first IP address which is set for the address translation device or the computer and an IP segment to which the first IP address belongs based on the sub-topology information while associating the first IP address with the IP segment; and when a second IP address is set for the computer, the control unit displays the second IP address in association with the first IP address into which the second IP address is translated by the address translation device.

Further preferably, the control unit displays the connection relation of the network in a tree structure on the viewer unit, and displays the first IP address as a child node of the IP segment and the second IP address as a child node of the first IP address on the viewer unit.

According to another aspect of the invention, there is provided a method for managing a network provided with network devices including one or more address translation units and a network management computer, wherein: the network management computer includes a control unit and a memory unit storing a program to be executed by the control unit; the control unit acquires, from each of the network devices, topology information indicating connection relation among the network devices; the control unit acquires, from each of the address translation units, address translation information indicating correspondence between a first IP address and a second IP address for each of first interfaces which are network interfaces of the address translation units, the correspondence being set for each of the first interfaces so that the first IP address and the second IP address can be translated from one to the other by the address translation device; the control unit specifies, for each of the first interfaces, a network device directly connected to the first interface or a network device connected to the first interface through another network device based on the topology information and the address translation information; and the control unit stores sub-topology information into the memory unit, the sub-topology information indicating correspondence between the first interface and the network device directly connected to the first interface or the network device connected to the first interface through the other network device.

### Advantageous Effects of Invention

A network administrator can rapidly and accurately grasp a list of IP hosts in operation in a network using NAT functions.

Other objects, features and advantages of the invention will be obvious from the following description of embodiments of the invention in conjunction with the accompanying drawings.

### BRIEF DESCRIPTION OF DRAWINGS

FIG. 1 A view showing a configuration example of a system to be managed.

FIG. 2 A view showing an example of NAT.

FIG. 3 A view showing a configuration example of NAT setting information.

FIG. 4 A view showing a configuration example of an ARP table.

FIG. 5 A view showing a configuration example of a NAT sub-topology management server.

FIG. 6 A view showing a configuration example of topology information.

FIG. 7 A view showing a configuration example of NAT sub-topology information.

FIG. 8 A view showing a configuration example of IP host information.

FIG. 9 A view showing a configuration example of group information.

FIG. 10 A view showing a configuration example of a group classification display screen when the background-art technology is used.

FIG. 11 A view showing a configuration example of a group classification display screen according to the invention.

FIG. 12 A view showing an overall sequence.

FIG. 13 A view showing a flow to generate NAT sub-topology information.

FIG. 14 A view showing a flow to analyze NAT setting information.

FIG. 15 A view showing a flow to register neighbor nodes into NAT sub-topology information.

FIG. 16 A view showing an example of a link list.

FIG. 17 A view showing an example of a list of neighbor nodes.

FIG. 18 A view showing examples of NAT sub-topologies.

FIG. 19 A view showing examples of NAT sub-topologies when VLANs are used.

FIG. 20 A view showing examples of NAT sub-topologies when VLANs and VRF are used.

FIG. 21 A view showing a flow to generate IP host information.

FIG. 22 A view showing a flow to register an ARP entry.

FIG. 23 A view showing a flow to register a group.

FIG. 24 A view showing a configuration example of a NAT sub-topology management server for IPv6.

FIG. 25 A view showing a configuration example of NDP information.

FIG. 26 A view showing an example of NAT from IPv6 addresses to IPv4 addresses.

FIG. 27 A view showing a configuration example of IP host information.

FIG. 28 A view showing an example of NAT from IPv4 addresses to IPv6 address.

FIG. 29 A view showing a configuration example of IP host information.

FIG. 30 A view showing an example of NAT from IPv6 addresses to IPv6 addresses.

FIG. 31 A view showing a configuration example of IP host information.

### DESCRIPTION OF EMBODIMENTS

(Same Configuration as that in Background-Art Technology)

A network management server according to the invention is provided with topology information, NAT setting information and an ARP table, in the same manner as a network management server according to the background art. Of them, the topology information is information which is provided for each of network interfaces of network devices in order to manage an identifier of a network device the network interface belongs to, an identifier of a network interface opposed thereto, and an identifier of a network device the opposed network interface belongs to. In addition, the NAT setting information is information for management of correspondence among an identifier of each NAT device, an identifier of a network interface of the NAT device, an IP address for publicizing external sites after conversion using NAT functions, and an IP address for internal communication before the conversion using the NAT functions. In addition, the ARP table is information for management of correspondence among an identifier of each network device, an identifier of each network interface, each IP address, and an address of each data link layer.

### (Configuration Peculiar to the Invention)

A network management server according to the invention is provided with NAT sub-topology information, IP host information, group information, a NAT sub-topology generator, and an IP host information generator as a peculiar configuration. Of the aforementioned configuration, the NAT sub-topology information is information for management of combinations of a network interface (NAT function executing interface) executing NAT functions of a network interface of each NAT device and a list of all network interfaces of other network devices which can be reached from the NAT function executing interface by IP communication.

In addition, of the aforementioned configuration, the IP host information is information in which IP hosts are classified in accordance with IP segments and groups separated by the NAT functions. The IP host information is information for management of entries each consisting of a combination of values including an identifier of a group, an IP address of an IP host, and further an IP address for publicizing external sites in the case where the IP host is an IP host whose IP address for publicizing external sites and IP address for internal communication are translated from one to the other by the NAT functions.

In addition, of the aforementioned configuration, the group information is information for management of IP segments each having different IP addresses inside the network and IP segments functioning as IP segments which have the same IP addresses but are independent due to address translation by the NAT functions. The group information is information for management of entries each consisting of a combination of pieces of information, i.e. a group ID for uniquely identifying the group, a network address of an IP segment, a NAT sub-topology ID expressing one entry of the NAT sub-topology information, a group ID of a group to which IP addresses for publicizing external sites belong, and a user name of a user using the group.

In addition, of the aforementioned configuration, the NAT sub-topology generator generates NAT sub-topology information from the topology information and the NAT setting information. This generator first retrieves a NAT device from a list of network devices. Successively, of network interfaces of the NAT device as a result of the retrieval, the generator retrieves network interfaces contained in the NAT setting information as NAT function executing interfaces. The generator uses the topology information to retrieve, from the NAT function executing interfaces as the retrieval result, all network interfaces which are present on the opposite sides of connection lines and which can be reached by IP communication. The generator gives an identifier to the set of the network interfaces as the retrieval result, so that the set of the network interfaces can be identified uniquely.

In addition, of the aforementioned configuration, the IP host information generator reads, from a network device having an ARP table within the network, information on the ARP table, and registers, into the IP host information, an entry which is unique in terms of a combination of an IP address and a NAT sub-topology ID corresponding to a network interface from which the IP address has been acquired. Moreover, the IP host information generator reads an IP segment the network interface from which the IP address has been acquired belongs to, and registers, into the group information, an entry which is unique in terms of a combination of the IP segment and the NAT sub-topology ID. With provision of the configuration having such information and generators, the network management server according to the invention can manage IP addresses and IP segments which have duplicate values inside the network but which can function independently after address translation using the NAT functions, based on the topology information, the NAT setting information and the ARP table.

Embodiments of the invention will be described below with reference to the drawings.

### Embodiment 1

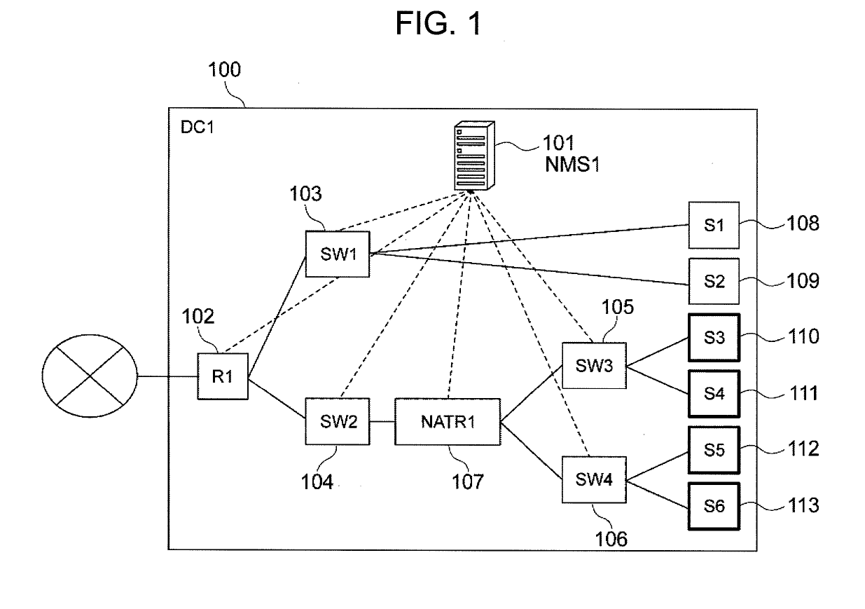

FIG. 1 shows a configuration example of a network system to be managed by a NAT sub-topology management server according to the invention. The NAT sub-topology management server NMS1 (101) according to the invention manages a network constituted by a router R1 (102), Ethernet switches SW1 to SW4 (103 to 106), a NAT-compatible router NATR1, and servers S1 to S6, which are disposed inside a data center DC1 (100). The network to be managed is connected from respective bases of clients of a data center service through a wide area network WAN1 of a wide area networking service provided by a carrier.

In this example, the router R1 (102) is connected to the wide area network WAN1. In addition, the router R1 (102) is connected to the switches SW1 (103) and SW2 (104). In addition, the SW2 (104) is connected to the NAT-compatible router NATR1. In addition, the NAT-compatible router NATR1 is connected to the switches SW3 (105) and SW4 (106). Further, each of the SW1 (103), the SW3 (105) and the SW4 (106) is connected to two servers.

In addition, the NAT sub-topology management server NMS1 (101) is directly connected to the router, the switches, the NAT-compatible router and the servers by cables for management network. The cables are different from cables for data network for connecting the router, the switches, NAT-compatible router and the servers with one another.

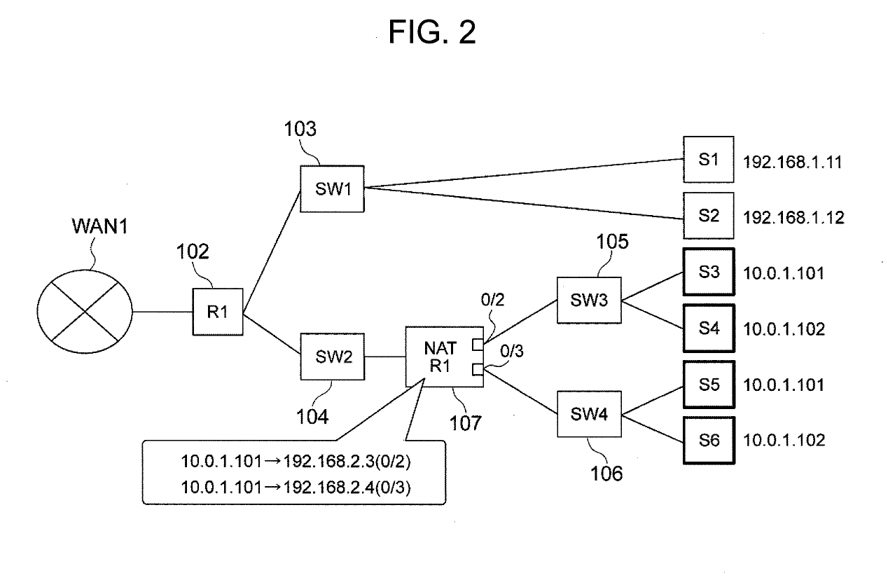

FIG. 2 shows an example of NAT in the network example. In this example, IP addresses 192.168.1.11, 192.168.1.12, 10.0.1.101, 10.0.1.102, 10.0.1.101, and 10.0.1.102 are first set for the servers S1 to S6 respectively. That is, the server S3 (110) and the server S5 (112) are IP hosts having one and the same IP address and the server S4 (111) and the server S6 (113) are IP hosts having one and the same IP address. These servers S3 to S6 (110 to 113) indicate a state in which IP addresses of the servers S3 to S6 (110 to 113) used by clients are duplicate in the case where the clients do not change but directly use the IP addresses which had been used in an existing environment till the servers S3 to S6 (110 to 113) were accommodated into the data center.

Here, the NAT-compatible router NATR1 performs a NAT process so that the servers S3 (110) and S5 (112) can be regarded as independent IP hosts from the outside. Therefore, the NAT-compatible router NATR1 manages correspondence among source IP addresses, conversion IP addresses, and output interfaces. Here, an IP address for an IP packet transferred at an interface 0/2 is set to be translated from 10.0.1.101 (private IP address) for internal communication to 192.168.2.3 (global IP address) for publicizing external sites. An IP address for an IP packet transferred at an interface 0/3 is set likewise to be translated from 10.0.1.101 to 192.168.2.4.

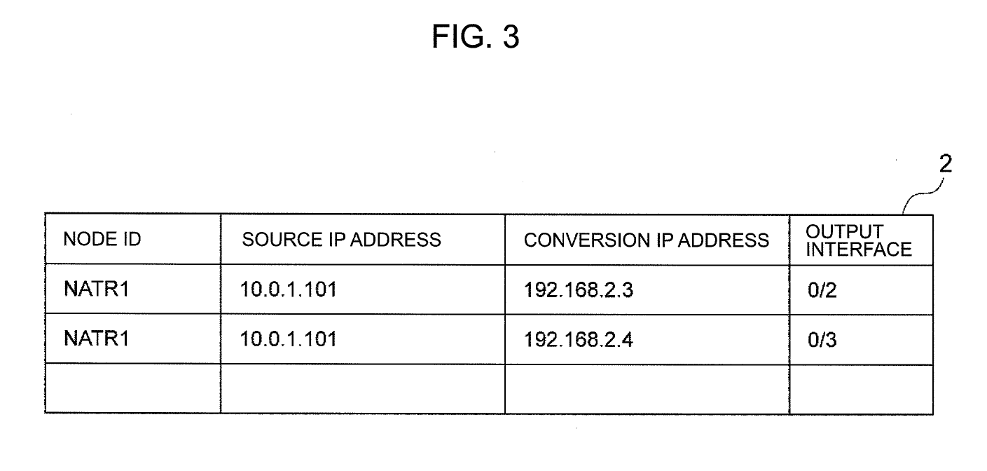

FIG. 3 shows a configuration example of NAT setting information used when the correspondence is centrally managed by the NAT sub-topology management server. The NAT setting information is constituted by a table in which each entry is set as a combination of a node ID, a source IP address, a conversion IP address and an output interface.

Here, the node ID means an identifier for uniquely identifying one of the router, the switches and the NAT-compatible router disposed in the network to be managed. The source IP address means the aforementioned IP address for internal communication, which IP address is assigned to an IP host. The conversion IP address means the aforementioned IP address for publicizing external sites, which IP address is used by a NAT process. The output interface means an identifier for designating an interface at which the NAT process is executed in the device designated by the node ID. In this example, the aforementioned two sets of IP addresses which are subjected to the NAT process are registered.

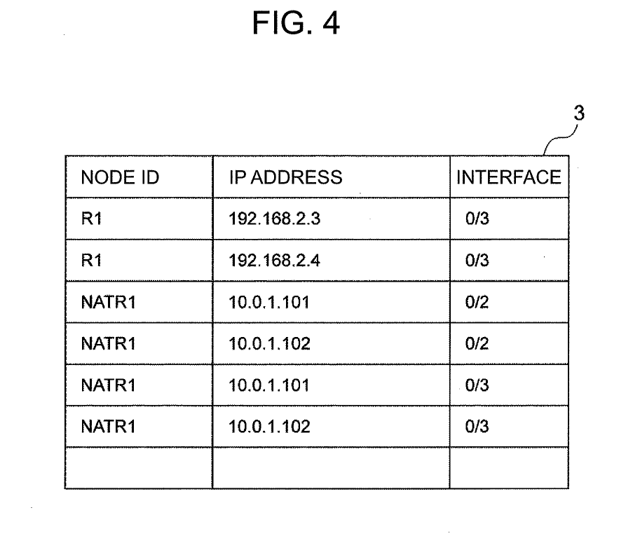

FIG. 4 shows a configuration example of an ARP table 3 used when an ARP cache of a router is centrally managed by the NAT sub-topology management server. The ARP table is constituted by a table in which each entry is set as a combination of a node ID, an IP address and an interface ID.

Here, the node ID means the same identifier as that for the node ID of the NAT setting information. The IP address expresses an IP address learned by the router based on ARP. The interface expresses an intra-node identifier of an interface on which the IP address has been learnt based on ARP.

In this example, two entries corresponding to two IP addresses at an interface 0/3 of the router R1 (102) are registered and four entries in total corresponding to two IP addresses at each of interfaces 0/2 and 0/3 of the NAT-compatible router are registered.

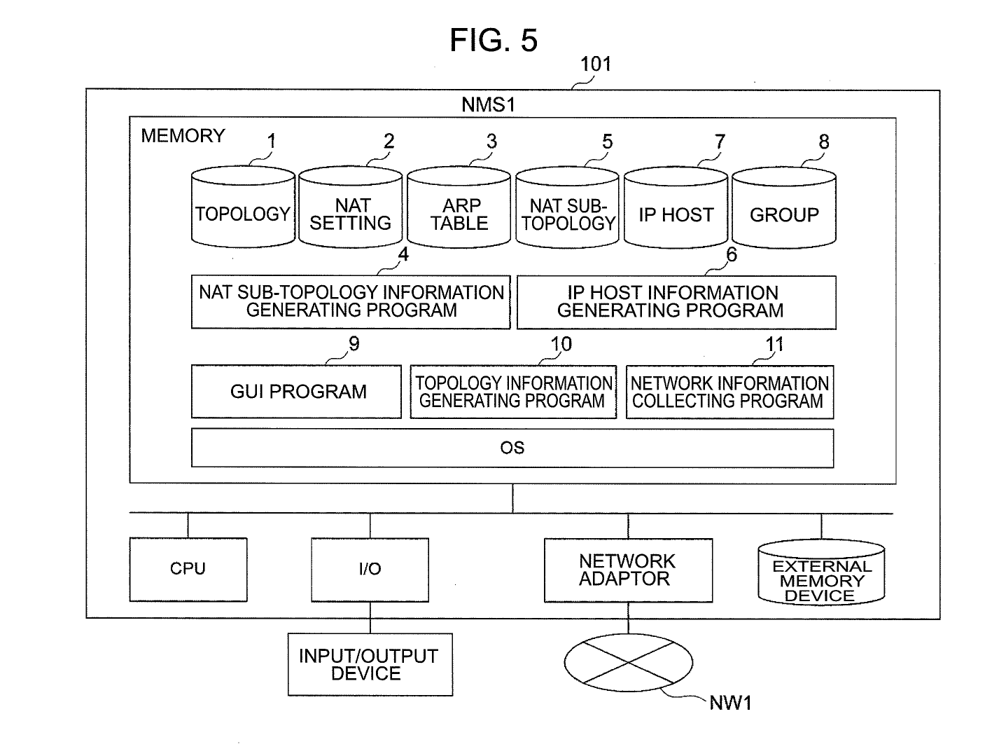

FIG. 5 shows a configuration example of the NAT sub-topology management server NMS1 (101) according to the invention. This NAT sub-topology management server NMS1 (101) is provided with a CPU, a memory, an I/O connecting an input/output device, a network adaptor connecting the NAT sub-topology management server NMS1 (101) to the external network NW1, and an external memory device. In the NAT sub-topology management server NMS1 (101), topology information 1 collected from the switches, the aforementioned NAT setting information 2 collected from the NAT-compatible router, and the ARP table 3 collected from the router are provided on the memory. Likewise, NAT sub-topology information 4, NAT sub-topology information 5, an IP host information generator 6, IP host information 7, group information 8, a GUI program 9, a topology information generating program 10, and a network information collecting program 11 are provided on the memory. Incidentally, these programs are stored on the memory of the NAT sub-topology management server NMS1 (101). When these programs are executed by the CPU, the functions built in the respective programs are executed.

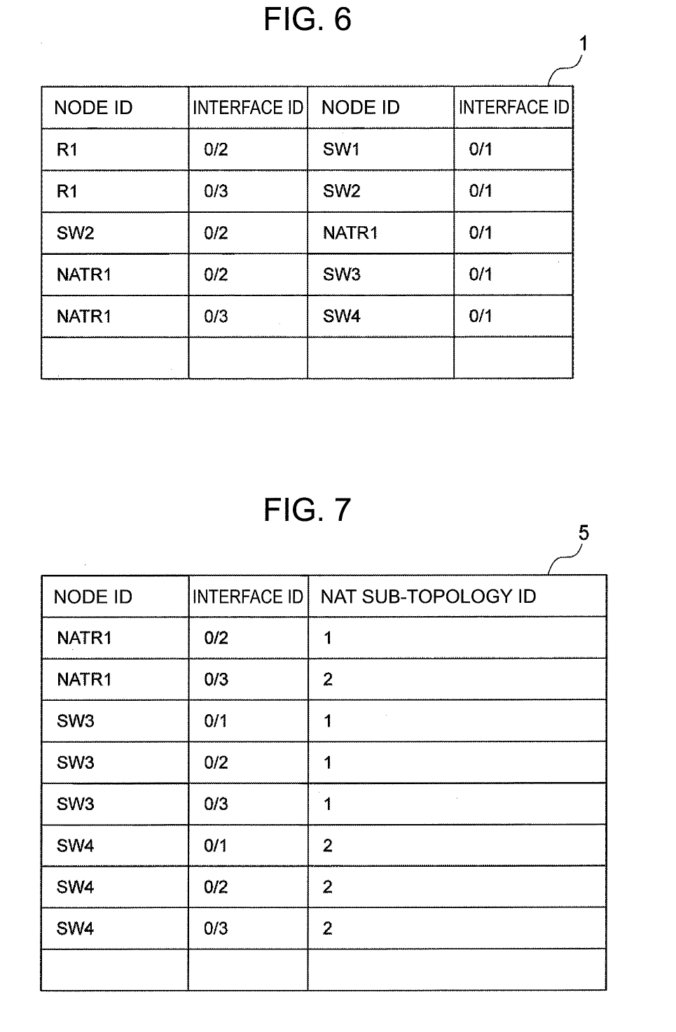

FIG. 6 shows a configuration example of the topology information 1. The topology information 1 is information indicating connection relation among network devices constituting the network. The topology information 1 is expressed by a table in which each entry is set as a combination of four pieces of information, i.e. a node ID and an interface ID of one of two devices connected directly to each other and a node ID and an interface ID of the other device.

In this example, five entries indicating connection between the router R1 (102) and the switch SW1 (103), connection between the router R1 (102) and the switch SW2 (104), connection between the switch SW2 (104) and the NAT-compatible router NATR1, connection between the NAT-compatible router NATR1 and the switch SW3 (105), and connection between the NAT-compatible router NATR1 and the switch SW4 (106) are registered in the topology information 3.

FIG. 7 shows a configuration example of the aforementioned NAT sub-topology information 5. The NAT sub-topology information 5 is information which is provided for each of interfaces of network devices inside the network in order to manage a NAT sub-topology the interface belongs to. Here, the NAT sub-topology represents a network topology in a range the NAT-compatible router can reach in the route on the network from one output interface thereof to the cable side. The NAT sub-topology information 5 is expressed by a table in which each entry is set as a combination of a node ID, an interface ID, and a NAT sub-topology ID.

In this example, interfaces 0/2 and 0/3 of the NAT-compatible router NATR1, interfaces 0/1 to 0/3 of the switch SW3 (105), and interfaces 0/1 to 0/3 of the switch SW4 (106) are registered with NAT sub-topologies respectively. Referring to the configuration of the network in FIG. 2 and the topology information 1 in FIG. 6, on this occasion, it can be known that it is possible to reach the interfaces 0/1 to 0/3 of the switch SW3 (105) from the interface 0/2 of the NAT-compatible router 1.

These four interfaces are given “1” as a NAT sub-topology ID corresponding thereto. Similarly, the interface 0/3 of the NAT compatible router NATR1 and the interfaces 0/1 to 0/3 of the switch SW4 (106) are given “2” as a NAT sub-topology ID corresponding thereto. That is, one and the same NAT sub-topology ID is assigned to one certain output interface of the NAT-compatible router, an interface of a network device directly connected to the output interface and any interface of a network device connected to the output interface through another network device.

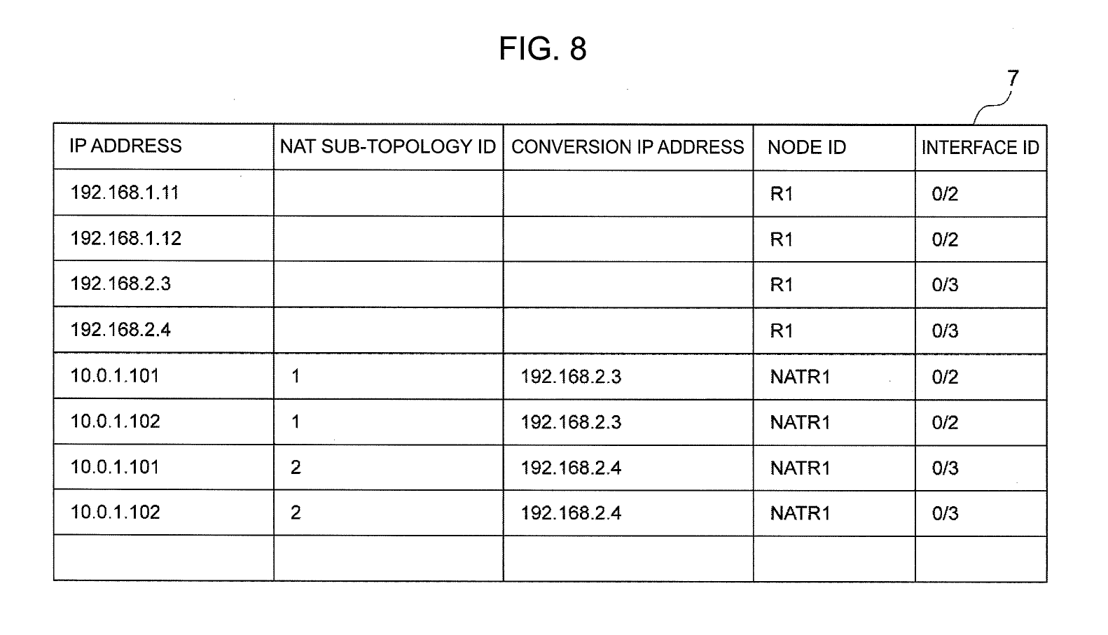

FIG. 8 shows a configuration example of the IP host information 7. The IP host information 7 is information for management of a list of independent IP hosts in operation inside the network. In addition, when an IP address of an IP host is a source IP address for internal communication before conversion using NAT functions, the IT host information 7 also manages correspondence between the IP address and an IP address for publicizing external sites after conversion.

The IP host information 7 is expressed by a table in which each entry is set as a combination of an IP address, a NAT sub-topology ID, a conversion IP address, a node ID, and an interface ID. Here, the IP address means an IP address assigned to an IP host, or a conversion IP address for publicizing external sites which IP address is assigned to the NAT-compatible router. In addition, the NAT sub-topology ID is a NAT sub-topology ID via which the IP host having the aforementioned IP address communicates with the outside. In addition, the node ID and the interface ID express an interface of a device with an ARP cache on the basis of which the piece of the IP host information is created.

In this example, eight entries are registered in the IP host information 7. 192.168.1.11 and 192.168.1.12 connected to the network not through the NAT process, 192.168.2.3 and 192.168.2.4 which are IP addresses for publicizing external sites after the NAT process, and two sets of 10.0.1.101 and 10.0.1.102 which are IP addresses for internal communication are registered as the eight entries in the IP host information 7.

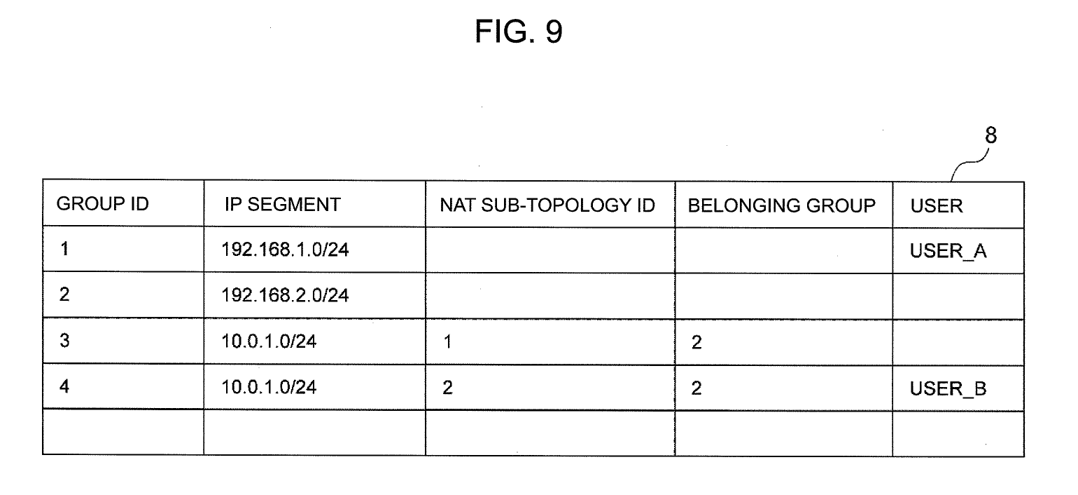

FIG. 9 shows a configuration example of the aforementioned group information 8. The group information 8 is information for management of a list of IP segments used inside the network. Differently from the background-art technology, IP segments to which source IP addresses subjected to the NAT process by the NAT-compatible router belong are managed independently for each output interface of the NAT process.

The group information 8 is expressed by a table in which each entry is set as a combination of pieces of information, i.e. a group ID for uniquely identifying an IP segment inside the network, a set of a network address and a subnet length of the IP segment, a NAT sub-topology ID, a belonging group, and a user name.

In this example, four groups are registered in the group information 8. 192.168.1.0/24, 192.168.2.0/24, 10.0.1.0/24 with a NAT sub-topology ID of 1 and 10.0.1.0/24 with a NAT sub-topology ID of 2 are registered as the four groups in the group information 8.

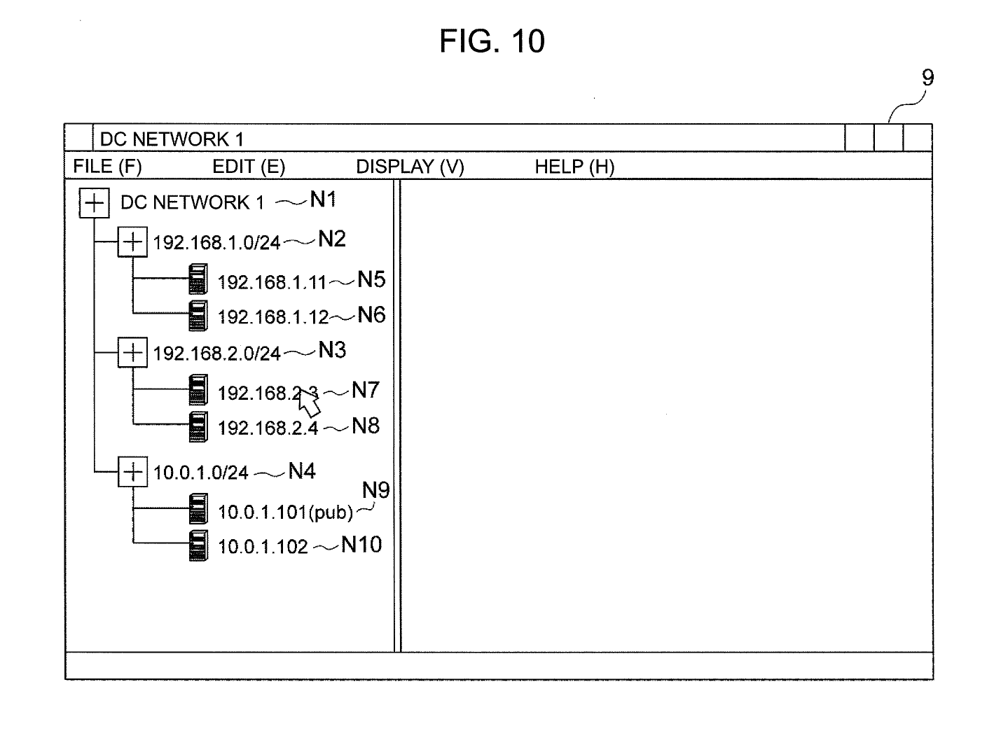

FIG. 10 shows a display example of a GUI 9 of the NAT sub-topology management server NMS1 (101), which displays a IP host classification result using the automatic discovery technology for IP hosts according to the background art in the configuration of the network system shown in FIG. 1. The GUI 9 displays a tree having IP segments as parent nodes and IP addresses as child nodes in a drawing area on the left side of FIG. 10. On that occasion, of a plurality of IP addresses discovered by the aforementioned discovery technology for IP hosts, any IP address whose belonging IP segment coincides with the IP segment of a parent node is selected as a child node thereof. In addition, any parent node having such IP segments as child nodes is also displayed on the tree.

In this example, nodes N2 to N4 representing IP segments are illustrated under a node N1 representing the entire network of the data center DC1 and nodes N5 to N10 representing IP addresses are illustrated under these nodes N2 to N4.

First, of these nodes, the IP segment of the node N2 represents an IP segment 192.168.1.0/24 used at the interface 0/2 of the router R1 (102) and all the interfaces of the switch SW1 (103). In addition, the IP segment of the node N3 represents an IP segment 192.168.2.0/24 used at the interface 0/3 of the router R1 (102) and all the interfaces of the switch SW2 (104) and the interface 0/1 of the NAT-compatible router. Further, the IP segment of the node N4 represents an IP segment 10.0.1.0/24 used at the interfaces 0/2 and 0/3 of the NAT-compatible router NATR1 and all the interfaces of the switches SW3 (105) and SW4 (106).

In this example, two IP segments which are assigned to the interfaces 0/2 and 0/3 of the NAT-compatible router NATR1 and which should be originally handled independently are displayed as one IP segment 10.0.1.0/24. For this reason, there is a problem that an administrator cannot accurately grasp the classification of IP segments of IP hosts in operation inside the data center DC1.

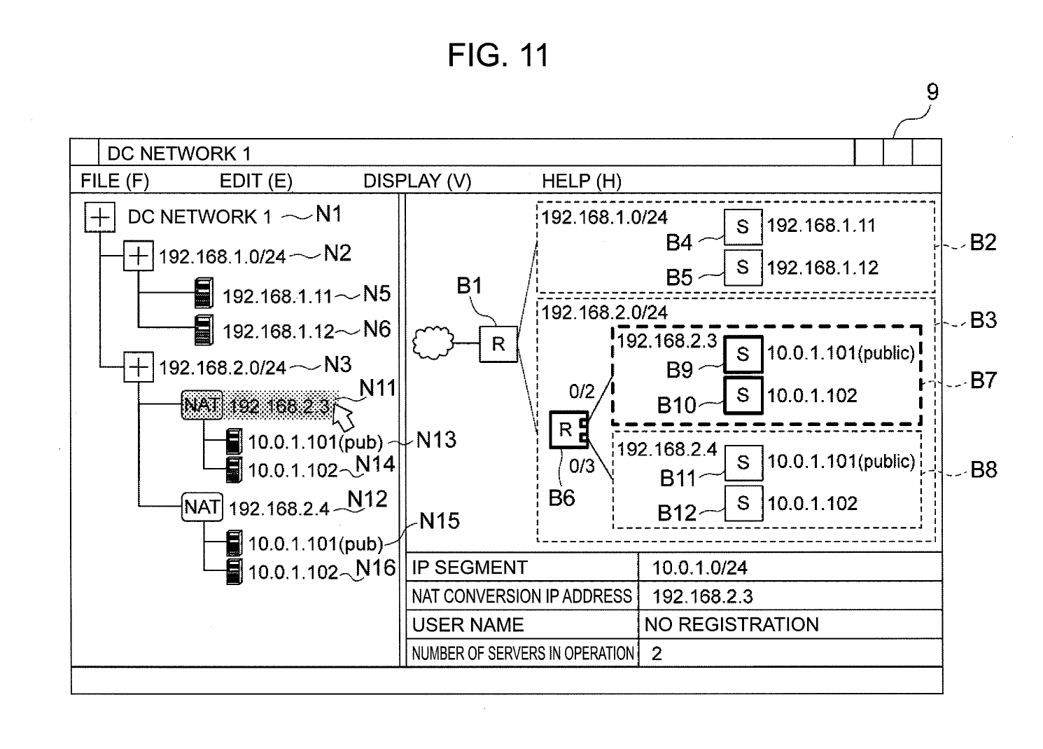

FIG. 11 shows a display example of the GUI 9 of the NAT sub-topology management server NMS1 (101) which displays a result of classification of IP hosts according to the invention and in the configuration of the network system shown in FIG. 1. The GUI 9 displays parent-child relationship among the entire network, IP segments and IP addresses in the form of a tree in the same manner as in the case of the background-art technology shown in FIG. 10, so as to display a node N1 representing the entire network, and nodes N2 and N3 representing IP segments.

Further, the GUI 9 according to the invention contains a plurality of nodes N11 and N12 representing an IP address 192.168.2.3 and an IP address 192.168.2.4 as child nodes of the node N3 corresponding to an IP segment. Further, nodes N13 and N14 representing IP addresses 10.0.1.101 and 10.0.1.102 are displayed as child nodes of the node N11. Further, nodes N15 and N16 representing IP addresses 10.0.1.101 and 10.0.1.102 are likewise displayed as child nodes of the output node N12.

In addition, the GUI 9 according to the invention does not display a node N4 corresponding to an IP segment 10.0.1.0/24 which would be displayed by the GUI 9 in the case of the background-art technology. This is because the IP segment 10.0.1.0/24 is an IP segment to which the output interfaces 0/2 and 0/3 of the NAT-compatible router NATR1 belong and which has been already represented by the nodes N13 to N16.

In addition, the GUI 9 displays information of a router, IP segments and IP hosts belonging to the IP segments by a graph in a drawing area on the right side of FIG. 11. Each of these pieces of information is displayed as a rectangular icon in this example. The GUI 9 indicates the relation between the router and the IP segments directly connected to the router by straight lines making connection among the icons. In addition, in the GUI 9 according to the invention, icons of IP hosts are illustrated inside the icons of the respective IP segments so that correspondence between each of the IP segments and one IP host or a plurality of IP hosts belonging to that IP segment is expressed. In the GUI 9 according to the invention, an icon of the NAT-compatible router is displayed inside an icon of an IP address for publicizing external sites and straight lines connecting the icon of the NAT-compatible router with icons of IP addresses for publicizing internal sites are further displayed, so as to express a state where the NAT-compatible router NATR1 has been set to perform a NAT process using these IP addresses for publicizing internal sites.

In this example, an icon B7 representing an IP segment 10.0.1.0/24 of one output interface of the NAT-compatible router NATR1 and an icon B8 representing an IP segment 10.0.1.0/24 of another output interface of the NAT-compatible router NATR1 are displayed to be connected to an icon B6 representing the NAT-compatible router NATR1 by straight lines.

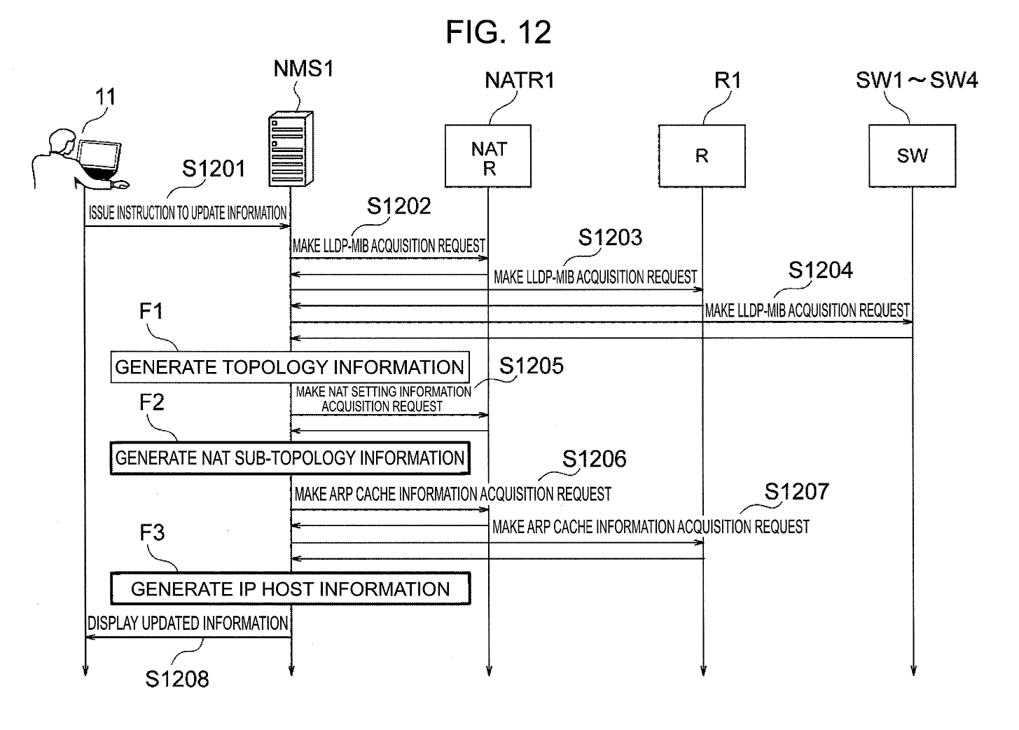

FIG. 12 shows a sequence in the case where an administrator uses the NAT sub-topology management server according to the invention to grasp the configuration of the network inside the data center DC1. The administrator 11 issues an instruction to update information to the NAT sub-topology management server NMS1 (101) according to the invention through the GUI or a command line interface (CLI) (S1201). The NAT sub-topology management server NMS1 (101) transmits LLDP-MIB acquisition requests for acquiring management information stored in LLDP-MIBs (Link-Layer Discovery Protocol MIB) to the NAT-compatible router NATR1, the router R1 (102) and the switches SW1 to SW4 inside the network (S1202 to S1204) to thereby acquire LLDP-MIB information containing information indicating connection relation with opposite connection devices, which information is stored in the LLDP-MIBs of the devices the requests are transmitted to. The NAT sub-topology management server NMS1 (101) according to the invention generates topology information 1 from the acquired LLDP-MIB information. Incidentally, although the method for generating the topology information 1 from the LLDP-MIBs has been shown here as the most general method, the administrator who can accurately grasp the connection relation among the devices may manually input a combination of a node ID and an interface ID of each opposite device to thereby generate the topology information 1 if the scale of the network is small.

Further, the NAT sub-topology management server NMS1 (101) according to the invention transmits a NAT setting information acquisition request to the NAT-compatible router NATR1 (S1205) to thereby acquire the contents of NAT setting information 2. NAT sub-topology information 5 is generated based on the NAT setting information 2 and the topology information 1 (F2).

Successively, the NAT sub-topology management server NMS1 (101) according to the invention transmits an ARP cache information acquisition request to the NAT-compatible router NATR1 and the router R1 (102) (S1206 and S1207) to thereby acquire ARP cache information from the NAT-compatible router NATR1 and the router R1 (102) so as to generate an ARP table 3. IP post information 7 and group information 8 are generated based on the ARP table 3 and the NAT sub-topology information 5 (F3).

Finally, the NAT sub-topology management server NMS1 (101) according to the invention displays a GUI 9 having the configuration shown in FIG. 11, based on the generated IP host information 7 and the generated group information 8 (S1208). Specifically, icons N5, N6, N13 to N16 representing IP hosts or icons N11 and N12 representing IP addresses after conversion using NAT functions are illustrated in the left area of the GUI 9 shown in FIG. 11 correspondingly to respective entries of the IP host information 7, and further icons B4, B5, and B9 to B12 representing the IP hosts having IP addresses other than the IP addresses after conversion using the NAT functions are illustrated in the right area of the GUI 9. In addition, icons representing IP segments are displayed in accordance with respective entries of the group information 8. The icons corresponding to the entries of the IP host information 7 are displayed to be disposed inside the icons corresponding to the entries of the group information 8 respectively so that the combination of the IP address and the NAT sub-topology in each entry of the IP host information 7 coincides with that in each entry of the group information 8.

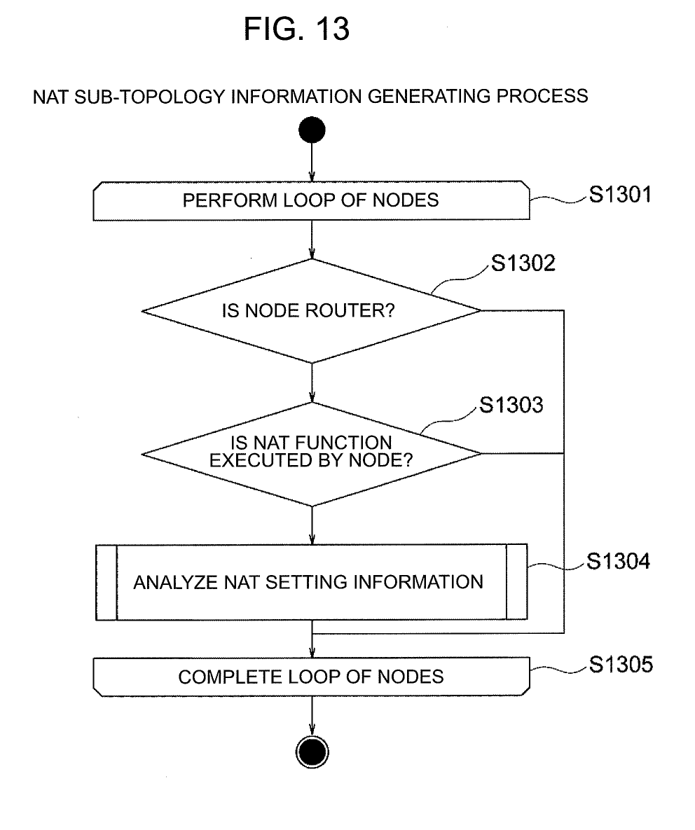

FIG. 13 shows an example of the NAT sub-topology generating flow F2 performed by the NAT sub-topology management server NMS1 (101) according to the invention.

When the flow starts, the NAT sub-topology management server NMS1 (101) first starts loop processing of all network devices (nodes) which are under management (S1301), so as to select one from the nodes. The NAT sub-topology management server NMS1 (101) checks whether the selected node is a router from which ARP cache information has been acquired or not (S1302). When the selected node is a router, the NAT sub-topology management server NMS1 (101) further checks whether the router can perform a NAT process function or not (S1303). As a result, when the selected node is a router and it is also a node having a NAT process function, the NAT sub-topology management server NMS1 (101) performs a process for analyzing NAT setting information as will be described later (S1304). However, when the selected node is not a router or when the selected node is a router not having a NAT process executing function, the process for analyzing NAT setting information is not performed. When these processes are performed on all the nodes, the loop processing of the nodes is completed (S1305), and the NAT sub-topology generating flow 2 is completed.

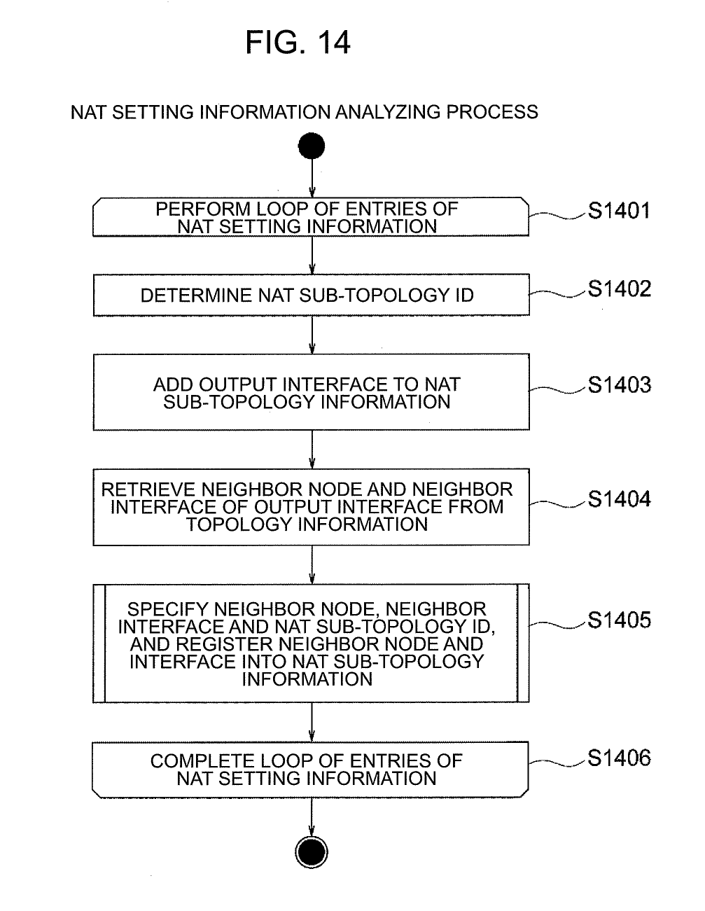

FIG. 14 shows an executing flow of the NAT setting information analyzing process S1304 performed by the NAT sub-topology management server NMS1 (101) according to the invention.

When the flow starts, the NAT sub-topology management server NMS1 (101) first starts loop processing of all entries included in the NAT setting information 2 (S1401) so as to determine a NAT sub-topology ID which is an identifier for uniquely identifying each of the entries in the NAT setting information (S1402). For example, the NAT sub-topology management server NMS1 (101) assigns an integer value starting from 1 sequentially to the NAT sub-topology ID whenever each entry is processed.

Successively, the NAT sub-topology management server NMS1 (101) according to the invention registers a combination of a node ID of the NAT-compatible router NATR1 from which the NAT setting information 2 has been acquired, a value of an output interface of a selected entry of the NAT setting information 2 and the determined value of the NAT sub-topology ID, as a new entry of NAT sub-topology information 5 (S1403). In this example, NATR1 is registered as the node ID, 0/2 is registered as the interface ID and 0 is registered as the sub-topology ID.

Successively, the NAT sub-topology management server NMS1 (101) according to the invention checks a node ID of a neighbor node and an interface ID of a neighbor interface in the output interface 0/2 of the NAT-compatible router NATR1 in the entry from the topology information 1 (S1404). In this example, the node ID of the neighbor node is SW3 (105) and the interface ID is 0/1.

Successively, the NAT sub-topology management server NMS1 (101) according to the invention designates the node ID of the neighbor node, the interface ID of the neighbor interface and the NAT sub-topology ID as arguments so as to execute a process for registering neighbor nodes/interfaces into NAT sub-topology information as will be described later (S1405). Upon completion of the process for registering neighbor nodes/interfaces, the NAT sub-topology management server NMS1 (101) completes the process concerned with the selected entry of the NAT setting information so as to return to the start of the loop to proceed with the processing on a next entry of the NAT setting information. Upon completion of the same processing on all the entries of the NAT setting information, the NAT sub-topology management server NMS1 (101) completes the loop of the NAT setting information (S1406) and completes the flow to analyze the NAT setting information.

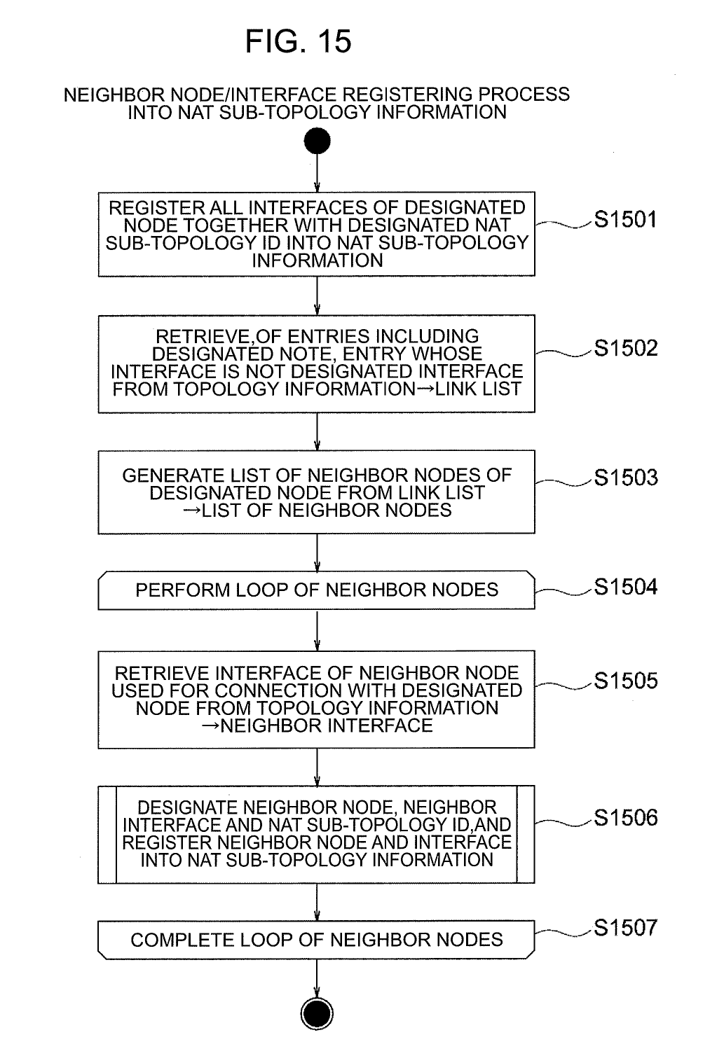

FIG. 15 shows a flow of the process for registering neighbor nodes/interfaces into the NAT sub-topology information, which process is performed by the NAT sub-topology management server NMS1 (101) according to the invention.

When the flow starts, the NAT sub-topology management server NMS1 (101) according to the invention first additionally registers, into the NAT sub-topology information 5, an entry in which each of interfaces of the node corresponding to the node ID designated as the argument in the aforementioned process S1405 is combined with the node ID of the node and the NAT sub-topology ID designated as the argument in the aforementioned step S1405 (S1501).

Successively, from all the entries of the topology information 1, the NAT sub-topology management server NMS1 (101) according to the invention extracts any entry in which one of its nodes ID coincides with the designated node ID but its interface ID paired with the designated node ID differs from the designated interface ID, and keeps the extracted entry as a link list (S1502). The NAT sub-topology management server NMS1 (101) extracts a list of node IDs other than the designated node ID contained in the link list and keeps it as a list of neighbor nodes (S1503).

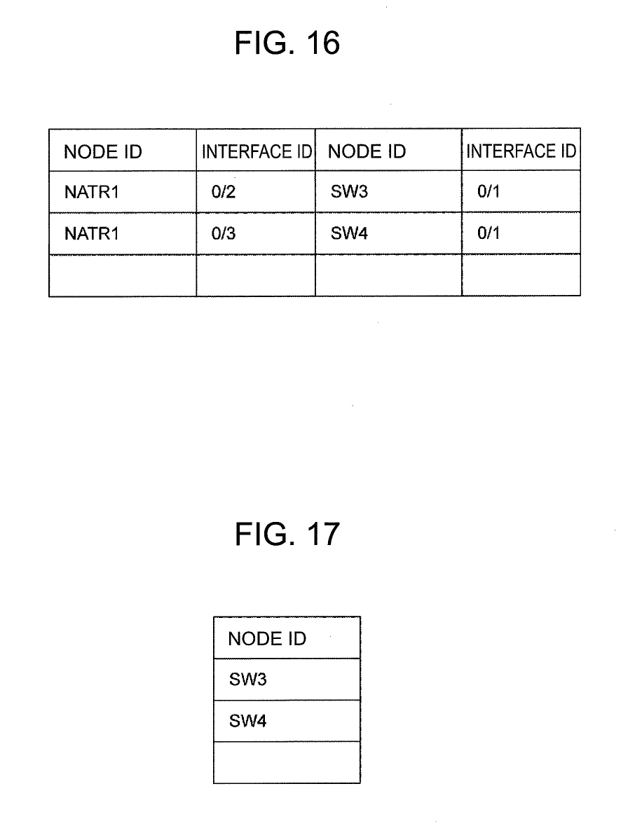

FIG. 16 shows a configuration example of the link list in the case where the ID of the NAT-compatible router NATR1 is designated as the node ID and 0/1 is further designated as the interface ID in the aforementioned process for registering neighbor nodes/interfaces. Two entries expressing, of links connected to the NATR1, two links excluding a link with the SW2 (104) connected to the interface 0/1 are registered in the link list.

Further, FIG. 17 shows a configuration example of a neighbor node list generated from the link list shown in FIG. 16 in the sequence S1503. Here, on the neighbor node list, the SW3 (105) and the SW4 (106) are recorded as the node IDs of all the neighbor nodes of the NAT-compatible router NATR1 excluding the designated node ID of the SW2 (104).

Successively, the NAT sub-topology management server NMS1 (101) according to the invention starts the loop of the nodes contained in the neighbor node list (S1504) so as to select one from the nodes contained in the neighbor node list. The NAT sub-topology management server NMS1 (101) retrieves, from the topology information 1, an interface ID of an interface of the selected node used for connection with the designated node and keeps the retrieved interface ID as a neighbor interface (S1505). The NAT sub-topology management server NMS1 (101) designates the node ID selected in the loop, the interface ID, and a NAT sub-topology ID designated at the beginning of the flow to register neighbor nodes/interfaces, and recursively executes the flow to register neighbor nodes/interfaces (S1506). Upon completion of these processes on all the nodes contained in the neighbor node list, the NAT sub-topology management server NMS1 (101) completes the loop of the neighbor nodes (S1507).

Upon completion of the series of processes, the NAT sub-topology management server NMS1 (101) according to the invention completes the flow to register neighbor nodes/interfaces and returns the process to the calling process, that is, the flow to register neighbor nodes/interfaces or the flow to generate NAT sub-topologies.

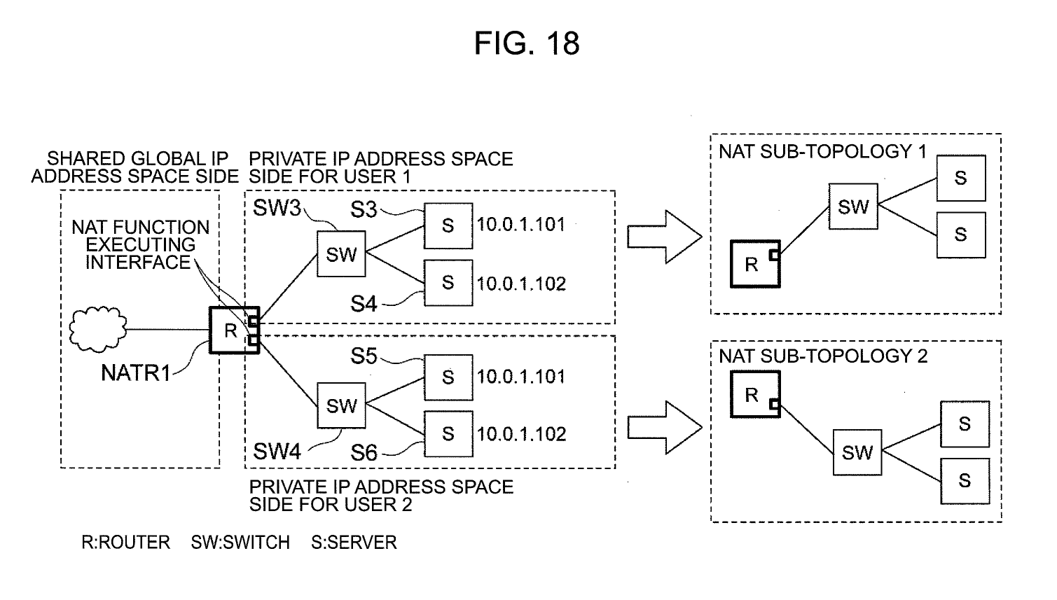

FIG. 18 shows a state in which NAT sub-topologies are generated in accordance with the aforementioned flow to generate NAT sub-topology information.

In this example, a combination of the switch SW3 (105), the server S3 (110) and the server S4 (111) connected to the interface 0/2 of the NAT-compatible router NATR1 is classified into one NAT sub-topology whose identifier is 1, and a combination of the switch SW4 (106), the server S5 (112) and the server S6 (113) connected to the interface 0/3 of the NAT-compatible router NATR1 is classified into one NAT sub-topology whose identifier is 2. In this manner, IP hosts having the same IP segment 10.1.0/24 can be identified uniquely inside the network by the combinations with the NAT sub-topology IDs respectively.

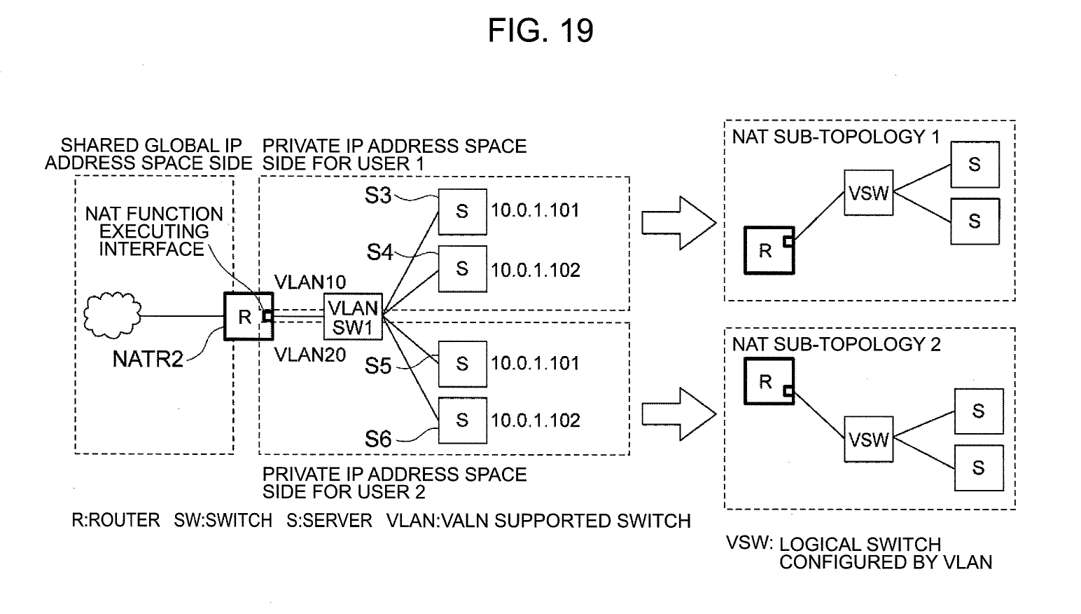

FIG. 19 shows a state in which NAT sub-topologies are generated by the NAT sub-topology management server NMS1 (101) according to the invention when a network having the same logical topology as the aforementioned network shown in FIG. 18 is configured using IEEE802.1Q tag VLANs (hereinafter referred to as VLANs).

In this example, a VLAN-compatible and NAT-compatible router NATR2 is connected to an interface 0/1 of a VLAN-compatible switch VALNSW1 at its interface 0/2. In addition, servers S3 to S6 are connected to interfaces 0/2 to 0/5 of the VLAN-compatible switch VLANSW1 respectively. VLANs whose IDs are 10 and 20 respectively are set as VLANs permitted for communication using tagged frames, in the interface 0/2 of the NAT-compatible router NATR2 and the interface 0/1 of the VALN-compatible switch VLANSW1. In addition, the VLAN whose ID is 10 is set as a VLAN permitted for communication using untagged frames, in the interfaces 0/2 and 0/3 of the NAT-compatible switch VLANSW1. The VLAN whose ID is 20 is set likewise in the interfaces 0/3 and 0/4 of the NAT-compatible switch VLANSW1. On this occasion, each VLAN interface is designated as an output interface in NAT setting information 2.

In the case where the NAT sub-topology management server NMS1 (101) according to the invention generates NAT sub-topology information 5 in the network using such VLANs, the NAT sub-topology management server NMS1 (101) sets a node ID and an interface ID described in topology information 1 as an ID of a neighbor node and an ID of a neighbor interface only when a VLAN with one and the same ID in both opposite interfaces has been set as a VLAN permitted for communication in the process S1404 for retrieving neighbor nodes and neighbor interfaces in the aforementioned flow to generate NAT sub-topology information as shown in FIG. 13. In addition, also in the interface adding flow S1501 of the aforementioned flow to register neighbor nodes as shown in FIG. 15, of interfaces selected in this process, only interfaces which have been set to be permitted for communication in the VLAN whose ID coincides with the VLAN ID of the output interface of the NAT-compatible router NATTR2 are registered into the NAT sub-topology information 5.

In this example, a virtual interface 0/2.10 of the NAT-compatible router NATR2, a virtual interface 0/1.10 of the VLAN-compatible switch VLANSW 1, and the interfaces connecting the servers S3 and S4 are registered into a NAT sub-topology whose ID is 1. In addition, a virtual interface 0/2.20 of the NATR2, a virtual interface 0/1.20 of the VLANSW1, and the interfaces connecting the servers S3 and S4 are registered into a NAT sub-topology whose ID is 2.

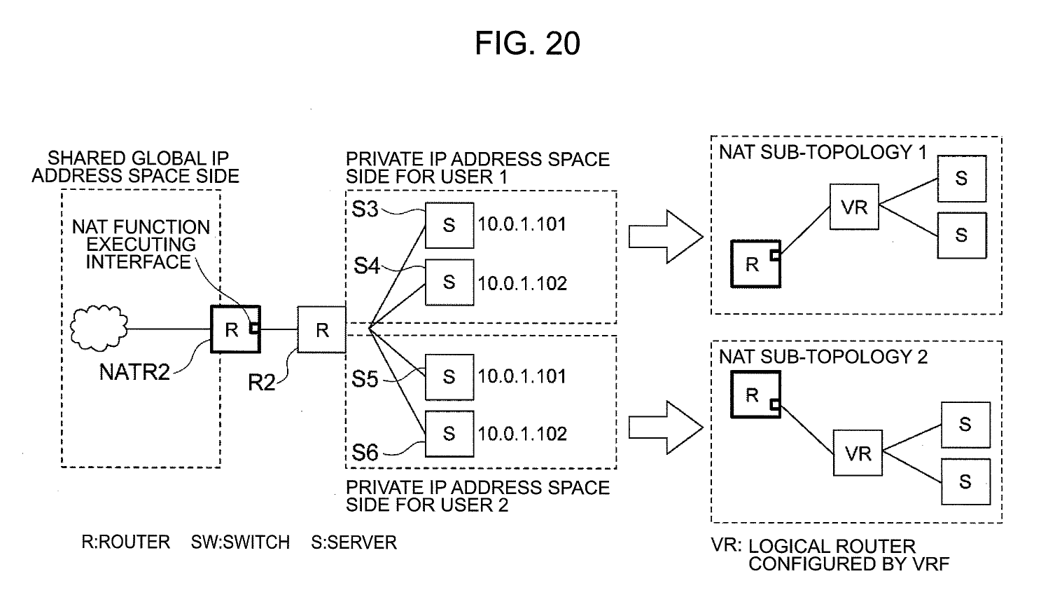

FIG. 20 shows a state in which NAT sub-topologies are generated by the NAT sub-topology management server NMS1 (101) according to the invention when the VLAN-compatible switch VLANSW1 in the aforementioned network shown in FIG. 19 is replaced by a router R2 compatible with a virtual router function.

In this example, the method for setting VLANs between the interface 0/2 of the NAT-compatible router NATR2 and an interface 0/1 of the router R2 is the same as in the aforementioned case between the NAT-compatible router NATR2 and the VLAN-compatible switch VLANSW1 in FIG. 19. However, the ID of a VLAN permitted for communication is set as 30 for interfaces 0/2 and 0/3 of the router R2 and the ID of a VLAN permitted for communication is set as 40 for interfaces 0/4 and 0/5 of the router R2. In addition, two virtual routers VR1 and VR2 are defined in the router R2. Of these, the virtual router VR1 is set to perform IP routing between interfaces of the VLANs whose IDs are 10 and 30. In addition, the virtual router VR2 is set to perform routing between interfaces of the VLANs whose IDs are 20 and 40.

When the NAT sub-topology management server NMS1 (101) according to the invention generates NAT sub-topology information 5 in the network using such virtual routers, the NAT sub-topology management server NMS1 (101) sets not only interfaces belonging to each VLAN whose ID coincides with the VLAN ID of the VLAN interface of the NAT-compatible router NATR2 but also all interfaces accommodated by the virtual router performing EP routing on that VLAN, as interfaces to be added in the interface adding flow S1501 in the flow to register neighbor nodes in the aforementioned case of FIG. 19.

In this example, a combination of the virtual interface 0/2.10 of the NAT-compatible router NATR2, the virtual interface 0/1.10 of the router R2 and interfaces of the virtual router VR1 or the router R2 connecting the servers S3 and S4 constitutes one NAT sub-topology.

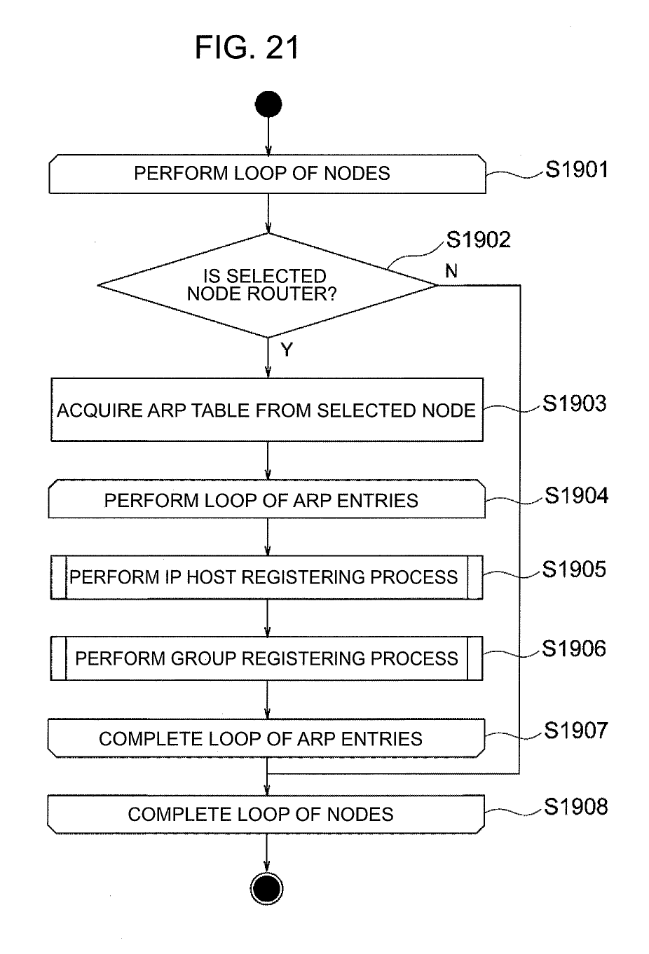

FIG. 21 shows, of the sequence shown in FIG. 12, a configuration example of the IP host information generating flow F3 performed by the NAT sub-topology management server NMS1 (101) according to the invention.

When the flow starts, the NAT sub-topology management server NMS1 (101) according to the invention starts loop processing of all devices to be managed (S1901) so as to select one from the nodes. The NAT sub-topology management server NMS1 (101) checks whether the selected node is a router or not (S1902). When the selected node is not a router, the NAT sub-topology management server NMS1 (101) completes the processing concerned with the selected node and returns to the start of the loop so as to proceed with processing for a next node. On the contrary, when the selected node is a router, the NAT sub-topology management server NMS1 (101) acquires ARP cache information from the selected node and stores the acquired ARP cache information in an ARP table 3 (S1903). Here, the NAT sub-topology management server NMS1 (101) starts loop processing of all entries of the acquired ARP cache information (S1904) so as to select one from the entries. The NAT sub-topology management server NMS1 (101) executes IP host registration into IP host information 7, as will be described later, based on information contained in the selected entry and NAT sub-topology information 5 (S1905). Further, the NAT sub-topology management server NMS1 (101) executes group registration into group information 8, as will be described later, based on the information contained in the entry and the NAT sub-topology information 5 (S1906). Upon completion of the series of processes on the selected entry of the ARP cache information, the NAT sub-topology management server NMS1 (101) returns to the start of the loop of the entries of the ARP cache information so as to select a next entry to thereby repeat the same processing. Upon completion of the processing on all the entries of the acquired ARP cache information, the NAT sub-topology management server NMS1 (101) completes the loop of the ARP cache information (S1907). The NAT sub-topology management server NMS1 (101) returns to the start of the loop of the nodes to select a next node to thereby repeat the same processing. Upon completion of the processing on all the nodes, the NAT sub-topology management server NMS1 (101) completes the loop of the nodes (S1908). Upon completion of the series of processes, the NAT sub-topology management server NMS1 (101) completes the IP host information generating flow F3.

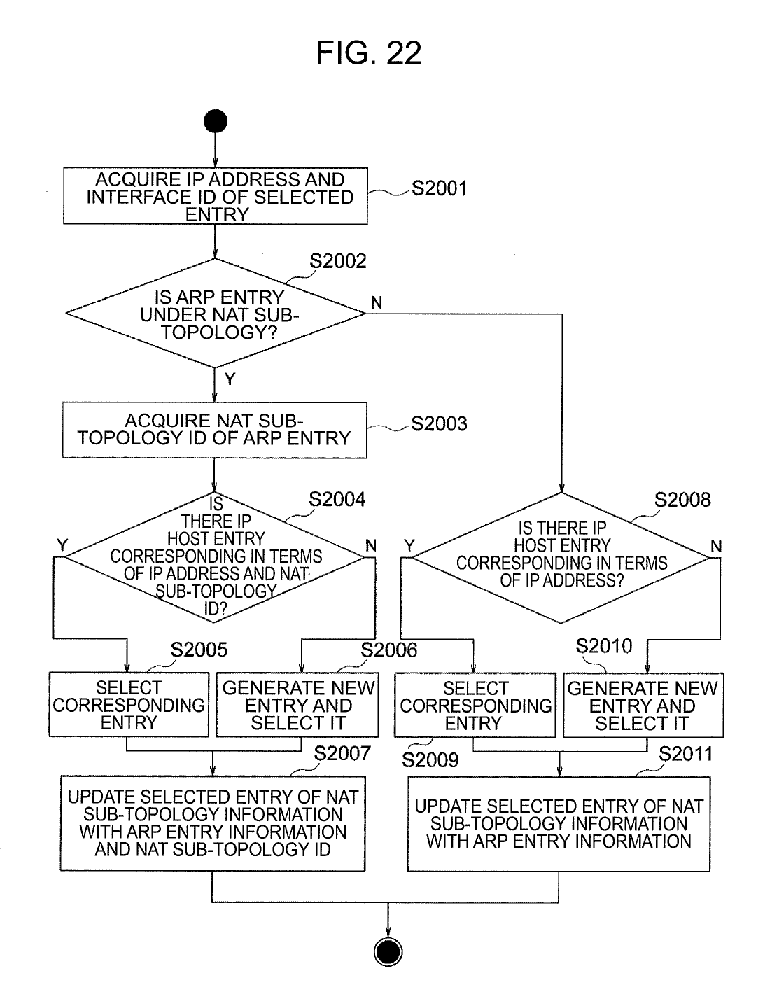

FIG. 22 shows a configuration example of the flow to register an IP host, which flow is performed by the NAT sub-topology management server NMS1 (101) according to the invention, in the aforementioned IP host information generating flow F3.

When the flow starts, the NAT sub-topology management server NMS1 (101) according to the invention acquires an IP address and an interface ID from a selected entry of ARP cache information (ARP entry) (S2001). Here, the NAT sub-topology management server NMS1 (101) retrieves NAT sub-topology information 5 to check whether an entry containing the interface ID of the acquired ARP entry and a node ID of a node from which the ARP entry has been acquired is present in the NAT sub-topology information 5 or not, so that the NAT sub-topology management server NMS1 (101) can check whether the interface from which the selected ARP entry was generated is an interface contained in a NAT sub-topology or not (S2002).

Here, when the interface recorded in the ARP entry is an interface contained in a NAT sub-topology, the NAT sub-topology management server NMS1 (101) retrieves a corresponding entry from the NAT sub-topology information 5 so as to acquire a NAT sub-topology ID corresponding to the interface (S2003). The NAT sub-topology management server NMS1 (101) checks whether an entry corresponding in terms of the combination of the value of the IP address of the ARP entry and the NAT sub-topology ID is present in IP host information 7 or not (S2004). When a corresponding entry is present, the NAT sub-topology management server NMS1 (101) selects the corresponding entry as an entry to be processed (S2005). On the contrary, when no corresponding entry is present, the NAT sub-topology management server NMS1 (101) generates a new entry in the IP host information 7 and selects the generated new entry as an entry to be processed (S2006). The NAT sub-topology management server NMS1 (101) registers, in the selected entry of the IP host information 7, the value of the IP address of the selected ARP entry, the value of the NAT sub-topology ID corresponding to the ARP entry, an IP address for publicizing external sites, and the node ID and the interface ID of the node recorded in the ARP entry (S2007).

Differently from the aforementioned case, when the interface recorded in the ARP entry is an interface not included in a NAT sub-topology, the NAT sub-topology management server NMS1 (101) checks whether an entry whose IP address value coincides with the IP address value of the ARP entry but whose NAT sub-topology ID is blank is present in the IP host information 7 or not (S2008). When an entry satisfying this condition is present, the NAT sub-topology management server NMS1 (101) selects the entry as an entry to be processed (S2009). On the contrary, when no entry satisfying this condition is present in the IP host information 7, the NAT sub-topology management server NMS1 (101) newly generates a new entry in the IP host information 7 and selects the generated new entry as an entry to be processed (S2010). The NAT sub-topology management server NMS1 (101) registers, in the selected entry of the IP host information 7, the value of the IP address of the selected ARP entry and the node ID and interface ID of the node recorded in the ARP entry (S2010).

Upon completion of the series of processes, the NAT sub-topology management server NMS1 (101) completes the flow to register an IP host into the IP host information 7.

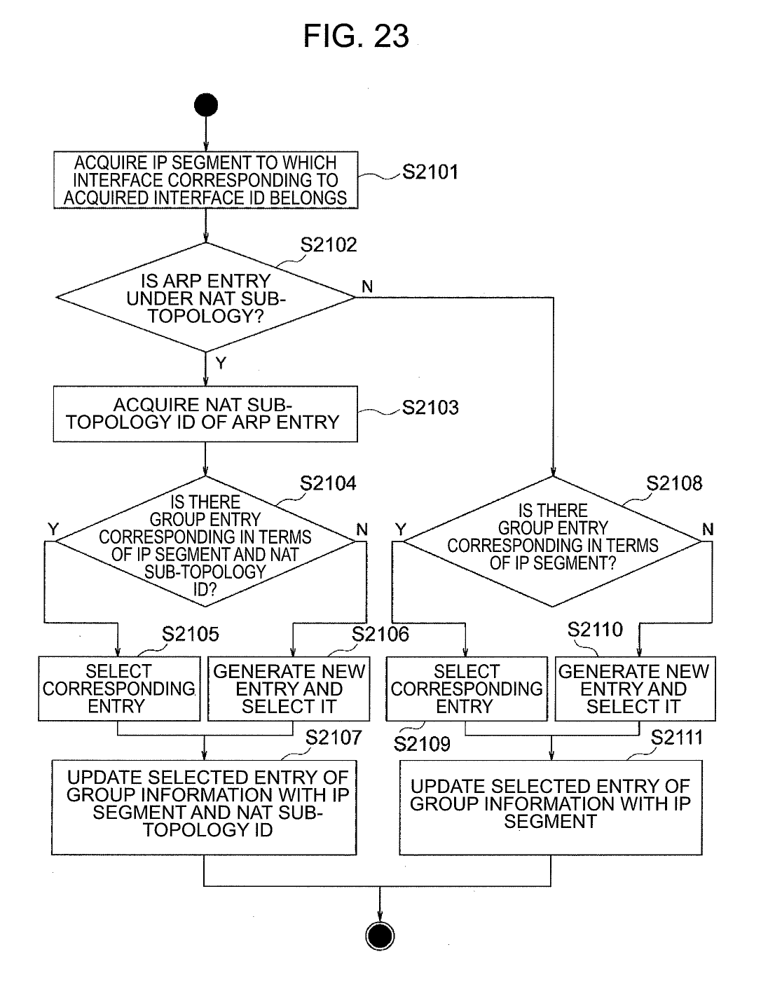

FIG. 23 shows a configuration example of the flow to register a group, which flow is performed by the NAT sub-topology management server NMS1 (101) according to the invention, in the aforementioned IP host information generating flow F3.

When the flow starts, the NAT sub-topology management server NMS1 (101) according to the invention checks an IP segment of the IP address assigned to the interface from which the ARP entry selected at the start of the aforementioned loop S1904 of ARP entries has been acquired (S2101). Here, the NAT sub-topology management server NMS1 (101) retrieves the NAT sub-topology information 5 to check whether an entry containing the interface ID of the acquired ARP entry and a node ID of the node from which the ARP entry has been acquired is present in the NAT sub-topology information 5 or not so as to check whether the interface recorded in the selected ARP entry is an interface included in a NAT sub-topology or not (S2102).

Here, when the interface recorded in the ARP entry is an interface contained in a NAT sub-topology, the NAT sub-topology management server NMS1 (101) retrieves a corresponding entry from NAT sub-topology information 5 so as to acquire a NAT sub-topology ID corresponding to the interface (S2103). The NAT sub-topology management server NMS1 (101) checks whether an entry corresponding in terms of the combination of the value of the IP segment and the NAT sub-topology ID is present in group information 8 or not (S2104). When a corresponding entry is present, the NAT sub-topology management server NMS1 (101) selects the corresponding entry as an entry to be processed (S2105). On the contrary, when no corresponding entry is present, the NAT sub-topology management server NMS1 (101) generates, in the group information 8, a new entry to which a group ID is assigned for uniquely identifying the entry inside the group information 8, and selects the generated new entry as an entry to be processed (S2106). The NAT sub-topology management server NMS1 (101) registers, in the selected entry of the group information 8, the value of the IP segment, the value of the NAT sub-topology ID corresponding to the selected ARP entry and the group ID of the group corresponding in terms of the IP segment of the IP address for publicizing external sites (S2107).

Differently from the aforementioned case, when the interface recorded in the ARP entry is an interface not included in a NAT sub-topology, the NAT sub-topology management server NMS1 (101) checks whether an entry corresponding in terms of the value of the IP segment is present in the group information 8 or not (S2108). When a corresponding entry is present, the NAT sub-topology management server NMS1 (101) selects the corresponding entry as an entry to be processed (S2109). On the contrary, when no corresponding entry is present, the NAT sub-topology management server NMS1 (101) generates, in the group information 8, a new entry to which a group ID is assigned for uniquely identifying the entry inside the group information 8 and selects the generated new entry as an entry to be processed (S2110). The NAT sub-topology management server NMS1 (101) registers the value of the IP segment in the selected entry of the group information 8 (S2111).

Upon completion of the series of processes, the NAT sub-topology management server NMS1 (101) completes the flow to register a group into the group information 8.

As described above, according to the network management server in the first embodiment, the administrator can rapidly grasp a list of IP hosts in operation in a cloud service environment using NAT functions. In addition, the administrator can rapidly identify groups of IP hosts which have the same IP segment but which are used by different clients in the cloud service environment using the NAT functions. Moreover, the administrator can rapidly grasp correspondence among each IP address for publicizing external sites after conversion using the NAT functions, each IP address for internal communication before the conversion using the NAT functions, and each IP host existing in the same segment as an IP host having the IP address for internal communication, in the cloud service environment using the NAT functions.

### Embodiment 2

In a second embodiment of the invention, a network management server manages IP devices having IPv6 (Internet Protocol Version 6) addresses. The embodiment will be described below with reference to the drawings.

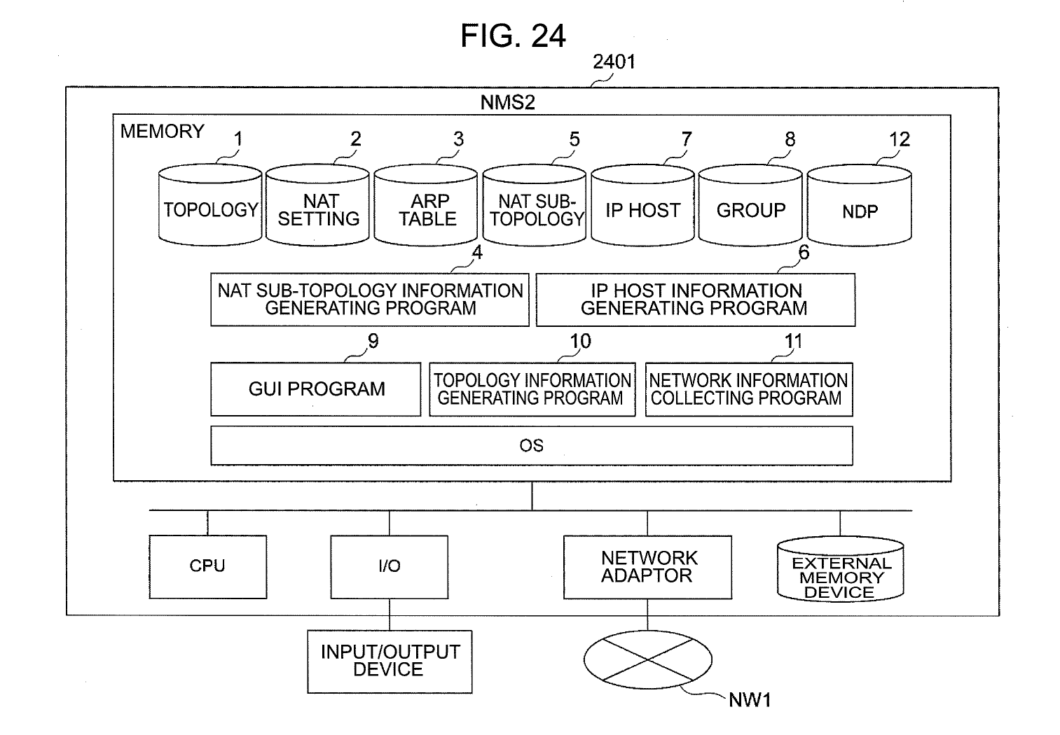

FIG. 24 shows a configuration example of a NAT sub-topology management server NMS2 (2401) according to the invention. The NAT sub-topology management server NMS2 includes a CPU, a memory, an I/O connecting an input/output device, a network adaptor connecting the NAT sub-topology management server NMS2 (2401) to an external network NW1, and an external memory device. In the NAT sub-topology management server NMS2 (2401), topology information 1 collected from switches, the aforementioned NAT setting information 2 collected from a NAT-compatible router, and an ARP table 3 collected from a router are provided on the memory. Likewise, NAT sub-topology information 4, NAT sub-topology information 5, an IP host information generator 6, IP host information 7, group information 8, a GUI program 9, a topology information generating program 10, and a network information collecting program 11 are provided on the memory. Further, the NAT sub-topology management server NMS2 (2401) according to the invention is provided with NDP (Neighbor Discovery Protocol) information 12 corresponding to the ARP table in an IPv6 network. The NDP information 12 holds NDP information collected from an IPv6-compatible router inside the network. Incidentally, these programs are stored on the memory of the NAT sub-topology management server NMS2 (2401). When these programs are executed by the CPU, the functions built in the respective programs are executed.

The NAT sub-topology management server NMS2 (2401) has the same configuration as that of the aforementioned NAT sub-topology management server NMS1 in the first embodiment except the NDP information. This is because the configuration of the table will not be affected when IP addresses registered in IP host information 7 and IP segments registered in group information are IPv4 (Internet Protocol Version 4) addresses or IPv6 addresses. In addition, the IP host registering flow S1905 and the group registering flow S1906 performed by the IP host information generator 6 can be also aimed at management of a network including IPv6 addresses in the same flows as those in the case of the NAT sub-topology management server NMS1 aimed at only IPv4 addresses.

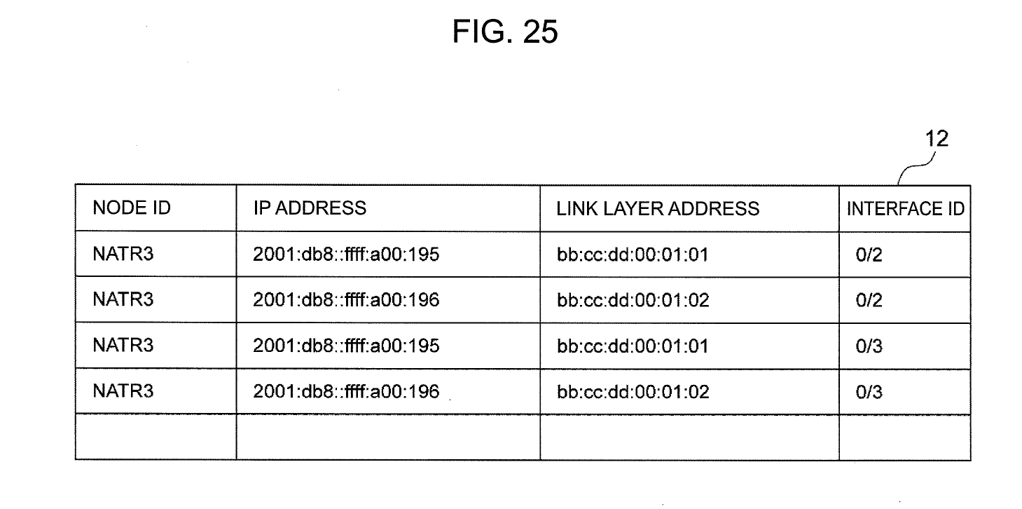

FIG. 25 shows a configuration example of the aforementioned NDP information 12. The NDP information 12 is constituted by a table in which each entry is set as a combination of a node ID, an IP address, a link layer address and an interface ID. Here, the node ID means an identifier for uniquely identifying, within the network, a source router from which information of each entry in the NDP information has been acquired. In addition, the IP address means an IPv6 address stored in a NDP cache of the router. Moreover, the link layer address means a physical address of a link layer corresponding to the IPv6 address. Moreover, the interface ID means an ID of an interface where an entry of the NDP cache corresponding to the IP address has been recorded.

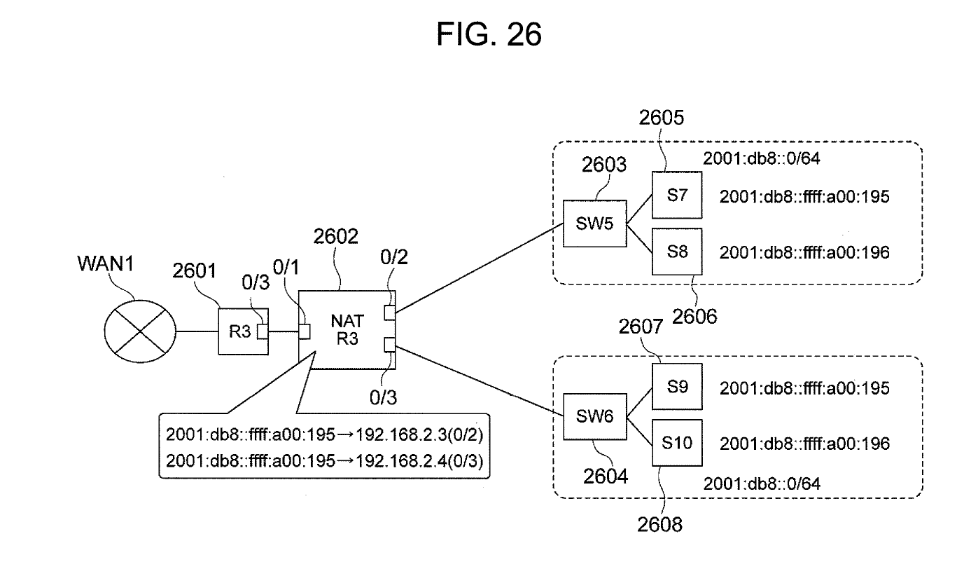

FIG. 26 shows a configuration example of a network to be managed by the NAT sub-topology management server NMS2 (2401) according to the invention. Configuration in which IPv6 addresses are used as IP addresses for internal communication and IPv4 addresses are used for publicizing external sites is shown here by way of example. A NAT-compatible router NATR3 (2602) connects a switch SW5 (2603) to its own interface 0/2 and connects a switch SW6 (2604) to its own interface 0/3. Further, the switch SW5 (2603) is connected to servers S7 (2605) and S8 (2606) whose IP addresses are set as 2001:db8::ffff:a00:195 and 2001:db8::ffff:a00:196 respectively. In addition, the switch SW6 (2604) is connected to servers S9 (2607) and S10 (2608) whose IP addresses are set as 2001:db8::ffff:a00:195 and 2001:db8::ffff:a00:196 respectively. Here, the NAT-compatible router NATR3 (2602) is set to perform translation between an IP address 192.168.2.3 for publicizing external sites and an IP address 2001:db8::ffff:a00:195 for internal communication and perform transfer through the interface 0/2. Likewise, the NAT-compatible router NATR3 (2602) is set to perform translation between an IP address 192.168.2.4 for publicizing external sites and an IP address 2001:db8::ffff:a00:195 for internal communication and perform transfer through the interface 0/3.

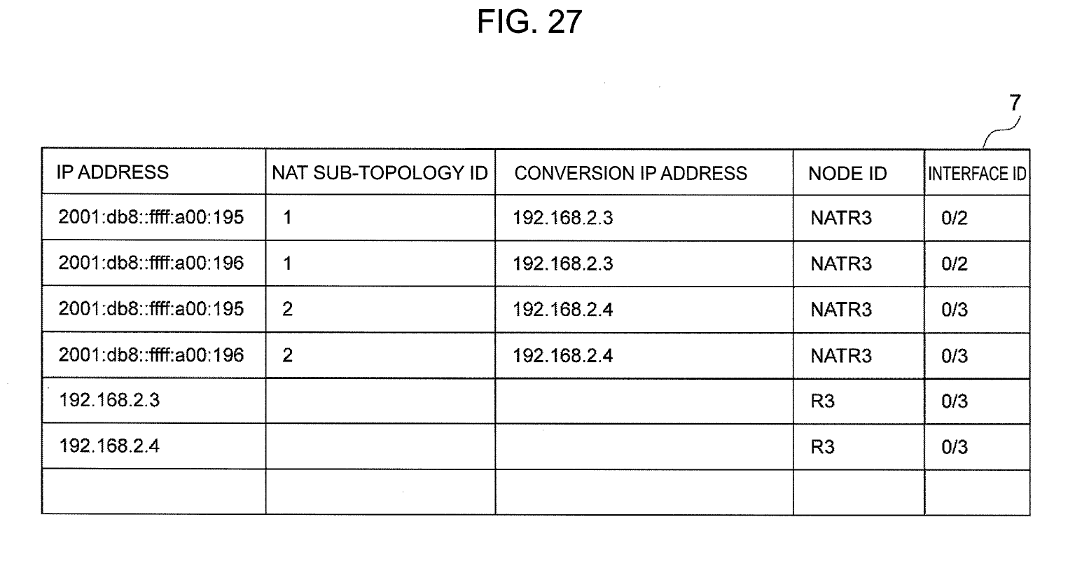

FIG. 27 shows configuration of IP host information 7 generated by the NAT sub-topology management server NMS2 (2401) according to the invention in the network having the aforementioned configuration shown in FIG. 26. In this example, four IPv6 addresses assigned to the servers S7 to S10 are stored as IP addresses.

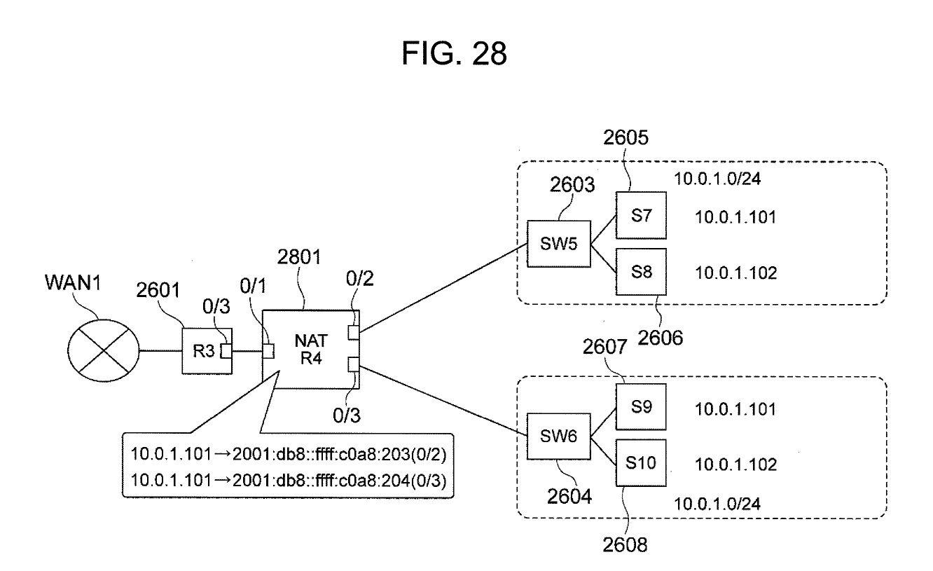

FIG. 28 shows a configuration example of a network to be managed by the NAT sub-topology management server NMS2 (2401) according to the invention. Configuration in which IPv4 addresses are used as IP addresses for internal communication and IPv6 addresses are used for publicizing external sites is shown here by way of example.

This configuration corresponds to configuration in which the NAT-compatible router NATR3 (2602) is replaced by a NAT compatible router NATR4 (2801) in the aforementioned network configuration in FIG. 27. Here, IP addresses 10.0.1.101, 10.0.1.102, 10.0.1.101, 10.0.1.102 for internal communication are assigned to the servers S7 to S10 (2605 to 2608) by way of example. The NAT-compatible router NATR4 (2801) is set to perform translation between an IP address 2001:db8::ffff:c0a8:203 for publicizing external sites and an IP address 10.0.1.101 for internal communication and perform transfer through an interface 0/2. Likewise, the NAT-compatible router NATR4 (2801) is set to perform translation between an IP address 2001:db8:ffff:c0a8:204 for publicizing external sites and an IP address 10.0.1.101 for internal communication and perform transfer through an interface 0/3.

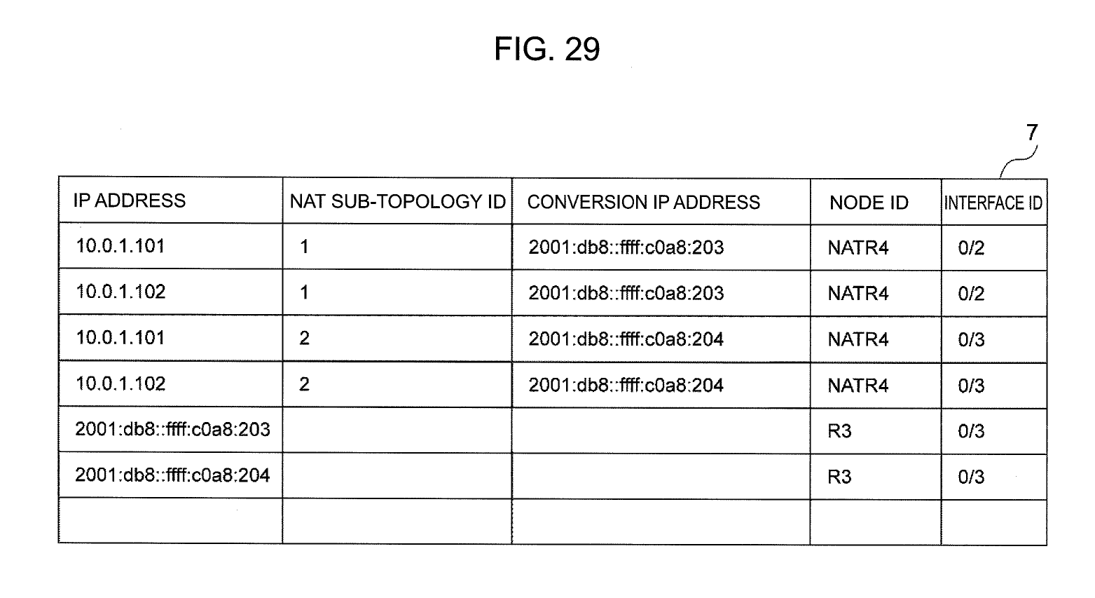

FIG. 29 shows configuration of IP host information 7 generated by the NAT sub-topology management server NMS2 (2401) according to the invention in the network having the aforementioned configuration shown in FIG. 28. In this example, four IPv4 addresses which are assigned to the servers S7 to S10 as IP addresses and two IPv6 addresses which are set in the NAT-compatible NATR4 as IP addresses for publicizing external sites are stored.

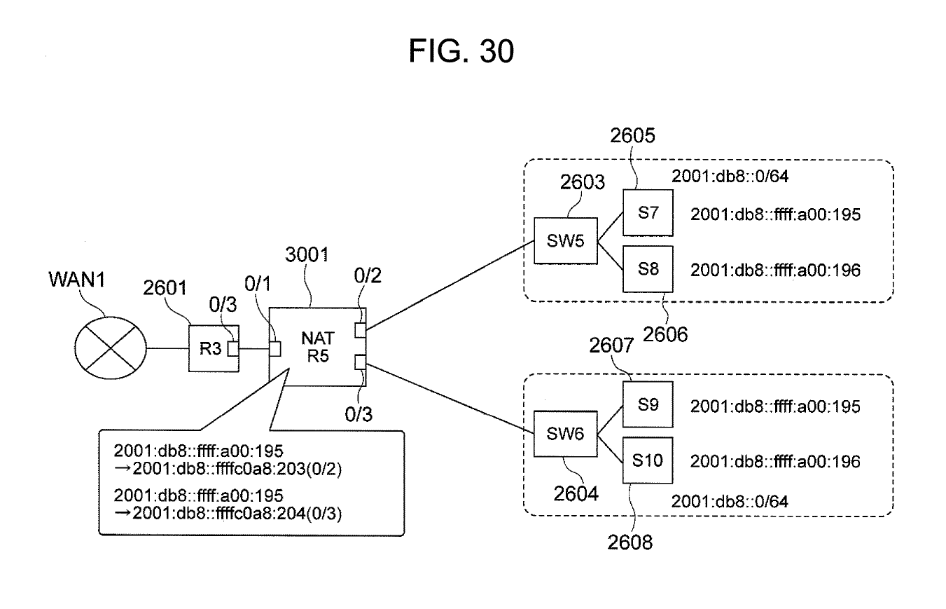

FIG. 30 shows a configuration example of a network to be managed by the NAT sub-topology management server NMS2 (2401) according to the invention. Configuration in which IPv6 addresses are used as both IP addresses for internal communication and IP addresses for publicizing external sites is shown here by way of example.

This configuration corresponds to configuration in which the NAT-compatible router NATR3 (2602) is replaced by a NAT-compatible router NATR5 (3001) in the aforementioned network configuration in FIG. 26. Here, IPv6 addresses 2001:db8::ffff:c0a8:203 and 2001:db8::ffff:c0a8:204 are assigned as IP addresses for publicizing external sites, and 2001:db8::ffff:a00:195, 2001:db8::ffff:a00:196, 2001:db8::ffff:a00:195 and 2001:db8::ffff:a00:196 are assigned as IP addresses of the servers S7 to S10 for internal communication by way of example.

The NAT-compatible router NATR5 (3001) is set to perform translation between the IP address 2001:db8::ffff:c0a8:203 for publicizing external sites and the IP address 2001:db8::ffff:a00:195 for internal communication and make transfer through an interface 0/2. Likewise, the NAT-compatible router NATR5 (3001) is set to perform translation between the IP address 2001:db8::ffff:c0a8:204 for publicizing external sites and the IP address 2001:db8::ffff:a00:195 for internal communication and make transfer through an interface 0/3.

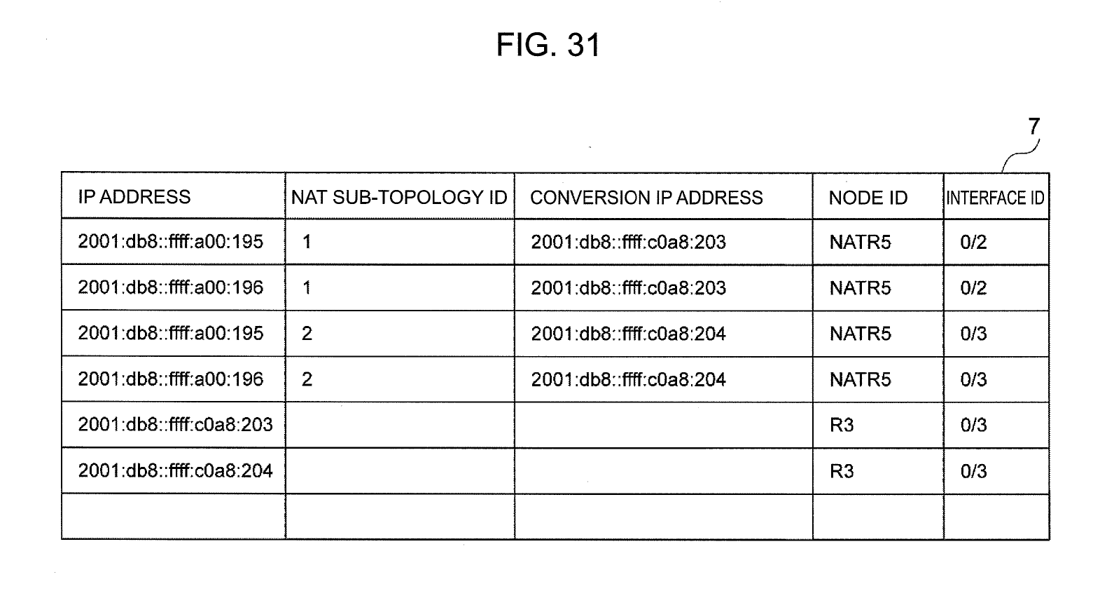

FIG. 31 shows configuration of IP host information 7 generated by the NAT sub-topology management server NMS2 (2401) according to the invention in the network having the aforementioned configuration shown in FIG. 30. In this example, four IPv6 addresses which are assigned to the servers S7 to S10 as IP addresses and two IPv6 addresses which are set in the NAT-compatible router NATR4 as IP addresses for publicizing external sites are stored.

As described above, according to the network management server in the second embodiment, a network administrator can rapidly grasp a list of IP hosts in a situation in which IP hosts in operation to which IPv4 addresses and IPv6 addresses are assigned are mixed in a cloud service environment using NAT functions.

The embodiments have been described above. However, the invention is not limited thereto. It is obvious to those skilled in the art that various changes and modifications can be made without departing from the spirit of the invention and the scope of the accompanying claims.

### REFERENCE SIGNS LIST

1 topology information
2 NAT setting information
3 ARP table
4 NAT sub-topology generator
5 NAT sub-topology information
6 IP host information generator
7 IP host information
8 group information
9 GUI
10 file
11 administrator
100 data center
101, 2401 NAT sub-topology management server
107, 2602, 2801, 3001 NAT-compatible router
102, 2601 router
103 to 106, 2603, 2604 switch
108 to 113, 2605 to 2608 server

1. A network management computer which is connected to network devices including one or more address translation devices, comprising:
a memory unit which stores topology information and address translation information, the topology information indicating connection relation among the network devices, the address translation information indicating correspondence between a first IP address and a second IP address for each of first interfaces which are network interfaces of the address translation units, the correspondence being set for each of the first interfaces so that the first IP address and the second IP address can be translated from one to the other by the address translation device; and
a control unit which specifies, for each of the first interfaces, a network device directly connected to the first interface or a network device connected to the first interface through another network device based on the topology information and the address translation information and stores sub-topology information into the memory unit, the sub-topology information indicating correspondence between the first interface and the network device directly connected to the first interface or the network device connected to the first interface through the other network device.

2. A network management computer according to claim 1, wherein:
when connection relation of a network including the network devices and the computer connected to the network devices is displayed on a viewer unit, the control unit displays a first IP address which is set for the address translation device or the computer and an IP segment to which the first IP address belongs based on the sub-topology information while associating the first IP address with the IP segment; and
when a second IP address is set for the computer, the control unit displays the second IP address in association with the first IP address into which the second IP address is translated by the address translation device.

3. A network management computer according to claim 2, wherein:
the control unit displays the connection relation of the network in a tree structure on the viewer unit, and displays the first IP address as a child node of the IP segment and the second IP address as a child node of the first IP address on the viewer unit.

4. A network management computer according to claim 1, wherein:
the control unit specifies, for each of the first interfaces, a second interface which is a network interface of the network device directly connected to the first interface or which is a network interface of the network device connected to the first interface through the other connection device, based on the topology information and the address translation setting information; and
the control unit stores information indicating correspondence between the first interface and the second interface as the sub-topology information in the memory unit.

5. A network management computer according to claim 4, wherein:
the sub-topology information is information indicating correspondence between the network interface of the network device and a sub-topology identifier; and
the sub-topology identifier is an identifier for uniquely identifying the first interface so that one and the same sub-topology identifier as that of the first interface to which the second interface is connected is set for the second interface.

6. A network management computer according to claim 5, wherein:
the memory unit stores IP host information for management of IP addresses set for the address translation devices and the computer connected to the network devices; and
when each of the IP addresses in the IP host information is a second IP address, the control unit stores the second IP address as the IP host information in the memory unit while associating a first IP address into which the second IP address is translated with the sub-topology identifier set for the first interface for which the first IP address is set, based on the sub-topology information.

7. A network management computer according to claim 6, wherein:
when connection relation of a network including the network devices and the computer is displayed on the viewer unit, the control unit displays a first IP address and an IP segment to which the first IP address belongs based on the IP host information while associating the first IP address with the IP segment; and
when a second IP address is set for the computer, the control unit displays the second IP address in association with the first IP address into which the second IP address is translated by the address translation device.

8. A network management computer according to claim 7, wherein:
the control unit displays the connection relation of the network in a tree structure on the viewer unit, and displays the first IP address as a child node of the IP segment and the second IP address as a child node of the first IP address on the viewer unit.

9. A network management computer according to claim 1, wherein:
the first IP address is a global IP address and the second IP address is a private IP address.

10. A network management computer according to claim 1, wherein:
the first IP address is an IP address in conformity with IPv6 and the second IP address is an IP address in conformity with IPv4.

11. A network management computer according to claim 1, wherein:
the first IP address is an IP address in conformity with IPv4 and the second IP address is an IP address in conformity with IPv6.

12. A method for managing a network provided with network devices including one or more address translation units and a network management computer, wherein:
the network management computer includes a control unit and a memory unit storing a program to be executed by the control unit;
the control unit acquires, from each of the network devices, topology information indicating connection relation among the network devices;
the control unit acquires, from each of the address translation units, address translation information indicating correspondence between a first IP address and a second IP address for each of first interfaces which are network interfaces of the address translation units, the correspondence being set for each of the first interfaces so that the first IP address and the second IP address can be translated from one to the other by the address translation device;
the control unit specifies, for each of the first interfaces, a network device directly connected to the first interface or a network device connected to the first interface through another network device based on the topology information and the address translation information; and
the control unit stores sub-topology information into the memory unit, the sub-topology information indicating correspondence between the first interface and the network device directly connected to the first interface or the network device connected to the first interface through the other network device.

13. A method for managing a network according to claim 12, wherein:
when the connection relation of the network including the network devices and the computer connected to the network devices is displayed on a viewer unit, the control unit displays a first IP address which is set for the address translation device or the computer and an IP segment to which the first IP address belongs based on the sub-topology information while associating the first IP address with the IP segment; and
when a second IP address is set for the computer, the control unit displays the second IP address in association with the first IP address into which the second IP address is translated by the address translation device.

14. A method for managing a network according to claim 12, wherein:
the control unit displays the connection relation of the network in a tree structure on the viewer unit, and displays the first IP address as a child node of the IP segment and the second IP address as a child node of the first IP address on the viewer unit.
